(19) United States
(12) Patent Application Publication
(10) Pub. No.: US 2026/0205697 A1
(43) Pub. Date: Jul. 16, 2026

(54) CONFERENCING SYSTEM FOR IMPROVED MEETING AND CONFERENCING METHODS

(71) Applicant: Logitech Europe S.A., Lausanne (CH)

(72) Inventors: Andrew Julian GARTRELL, Los Angeles, CA (US); John Scott SKEEHAN, San Ramon, CA (US); Vivek SEKAR, Pleasanton, CA (US); Karthik RAJAGOPAL, Cupertino, CA (US); Vijay Vidyanand KARNATAKI, Fremont, CA (US)

(21) Appl. No.: 19/248,387

(22) Filed: Jun. 24, 2025

Related U.S. Application Data
(63) Continuation-in-part of application No. 19/025,564, filed on Jan. 16, 2025.

(51) Int. Cl. H04N 23/695; H04N 7/15

(52) U.S. Cl. CPC H04N 23/695; H04N 7/15

(57) ABSTRACT

Embodiments of the disclosure generally include a method and apparatus for a conferencing display. The method includes detecting, by use of a plurality of microphones, an audible input from an input source, determining, by a controller, a direction of the audible input source based on a difference in time that two or more microphones of the plurality of microphones detected the audible input, generating, by use of an orientation sensor that is coupled to a camera sensor of a video conference assembly, an orientation signal, and using a camera actuator coupled to the camera sensor and a supporting structure of the video conference assembly to orient the camera sensor. The camera sensor is oriented towards the input source based on the determined direction and the orientation signal.

### CROSS-REFERENCE TO RELATED APPLICATIONS

This application is a Continuation-In-Part application of U.S. patent application Ser. No. 19/025,564, filed Jan. 16, 2025, which is incorporated by reference in its entirety herein.

### BACKGROUND

### Field

Embodiments of the present disclosure relate to methods and apparatuses that are configured to facilitate meetings and video conferencing types of activities.

### Description of the Related Art

The popularity and reliance on electronic devices has increased dramatically in the past decade. For example, the popularity of electronic devices, such as smart phones, touch pads, PDAs, portable computers, and portable music players for use as video conferencing devices has greatly increased in large part due to the proliferation of high speed Internet and price reductions in the supporting equipment. As the number of electronic devices and the reliance on these electronic devices has increased, there has been a desire for these devices to receive and process audible and visual inputs provided from a user so that the inputs can be generated and transmitted via a communication link.

Further, there is a desire for an electronic device that can receive, process, and/or transmit various types of audible and visual inputs provided during a meeting or video conferencing activity. Making these electronic devices seamlessly integrate into different work environments where a meeting or a video conference are to be performed has presented challenges. The challenges have increased in cases where a meeting or video conference is performed in non-conventional work environments, such as open areas or non-enclosed or partially enclosed conference room spaces, which can include undesirable distractions that reduce the effective presentation and transfer of information during the meeting or video conference. This inability to seamlessly integrate the electronic device into some types of work environments is in part due to the differing requirements for use of the electronic device when positioned in the different areas of the work environment or different numbers of users that are actively engaging with the electronic device during the meeting or a video conference. The differing requirements can cause a user of the electronic device to perform various manual calibrations and adjustments to the electronic device, which can be ineffective and time consuming.

Additionally, there is often a need for electronic devices that are positioned in open and uncontrolled environments that can protect key device components when the device is not in use and/or provide visual clues to a user regarding the current state of the electronic device.

Therefore, there is a need for an electronic device that solves the problems described above. Moreover, there is a need for an electronic device that is able to efficiently detect visual and audible inputs while filtering out unwanted noise from an audible input that is received from multiple audible sources positioned within various different environments.

### SUMMARY

Embodiments of the disclosure generally include a method and apparatus for a conferencing display. In one embodiment a display includes a structural member, a screen disposed within the structural member, and a sensor assembly coupled to the structural member. The sensor assembly includes an orientation sensor, a camera assembly aperture, and a camera assembly aligned with the camera assembly aperture. The camera assembly includes a camera sensor and a camera actuator, wherein the camera actuator is configured to adjust the orientation the camera sensor. In some embodiments, a controller is configured to cause the camera actuator to adjust the orientation of the camera sensor based on a detected orientation of the screen that is based on a signal generated by the orientation sensor and received by the controller and/or based on detected audible signals received from a plurality of microphones within the sensor assembly.

In another embodiment, a conferencing system assembly includes a structural member, a screen coupled to the structural member, a controller, and a sensor assembly. The sensor assembly is coupled to the structural member. The sensor assembly includes an orientation sensor coupled to a supporting structure of the sensor assembly, a first microphone aligned to receive sound from a first direction, a second microphone aligned to receive sound from a second direction that is opposite to the first direction, and a camera assembly. The camera assembly includes a camera sensor configured to deliver a communication signal to the controller, a camera actuator coupled to the camera sensor, the camera actuator configured to orient the camera sensor, and a camera body coupled to a portion of the camera actuator and the camera sensor.

In another embodiment, a conferencing system assembly includes a camera assembly, a first microphone assembly, a second microphone assembly, and a controller. The camera assembly is coupled to a base, and includes a camera sensor defining a detection vector oriented toward a detection region, and a camera actuator coupled to the base, the camera actuator configured to translate the camera sensor and orient the detection vector of the camera sensor toward the detection region. The first microphone assembly is coupled to a front surface of the base and facing a detection region, the first microphone assembly includes a first microphone, and a second microphone. The second microphone assembly is coupled to a rear surface of the base and facing a noise zone, the rear surface facing the noise zone. The controller includes a processor, and a memory having a stored program that when executed by the processor, performs a method of forming and transmitting a conference signal includes audio and video data. The method includes determining a time difference between when the first microphone receives an audible input from a target input source and when the second microphone receives the audible input, calculating a time delay ratio by comparing the time difference with a plurality of stored time delay ratios, determining that the time delay ratio is closer to a first stored time delay ratio than a second stored time delay ratio, the first stored time delay ratio is associated with a first direction and the second stored time delay ratio is associated with a second direction, orienting the detection vector in the first direction, and suppressing a noise input when forming the conference signal.

In another embodiment, a conferencing system assembly includes a camera assembly coupled to a base, a front microphone assembly, a rear microphone assembly, and a controller. The camera assembly includes a camera sensor having a detection region, and a camera actuator configured to adjust a position of the detection region relative to the base. The front microphone assembly directed towards the detection region, the front microphone assembly includes a first front microphone, and a second front microphone. The rear microphone assembly directed towards a rear zone, wherein the detection region and the rear zone are on opposite sides of the base. The controller includes a processor, and a memory having a stored program stored in the memory. The stored program includes a method to form and transmit a conference signal. The method includes detecting, by use of the front microphone assembly and the rear microphone assembly, audible input from a target input source, determining a direction of the target input source from the conferencing system assembly based on the detected audible input, and adjusting the position of the detection region relative to the target input source based on the determined direction of the target input source.

In another embodiment, a method includes detecting, by use of a plurality of microphones, an audible input from an input source, determining a direction of the audible input source based on a difference in time that two or more microphones of the plurality of microphones detected the audible input, generating, by use of an orientation sensor coupled to a supporting structure that is coupled to a camera sensor, an orientation signal, and orienting, by use of a camera actuator coupled to the supporting structure and the camera sensor, the camera sensor towards the input source based on the determined direction and the orientation signal.

In another embodiment, a method includes determining, by use of an orientation sensor, a screen orientation of a screen assembly by comparing an orientation sensor signal generated by the orientation to a first threshold value stored in memory, determining a camera sensor orientation, by use of an encoder coupled to the camera sensor, based on an encoder signal generated by the encoder, determining the orientation of the screen assembly relative to the camera sensor based on the orientation sensor signal and the encoder signal, and adjusting the orientation of the camera sensor relative to the screen assembly based on the orientation sensor signal and the encoder signal.

In another embodiment, a conferencing system assembly includes a structural member, a screen coupled to the structural member, and a sensor assembly coupled to the structural member. The sensor assembly includes an orientation sensor coupled to a frame of the sensor assembly, a first microphone coupled to the frame and aligned in a first direction, a second microphone coupled to the frame and aligned with a second direction, and a camera assembly. The camera assembly includes a camera sensor having a field of view, a camera actuator coupled to the camera sensor and configured to orient the camera sensor, and a camera body coupled to a portion of the camera actuator and the camera sensor.

In another embodiment, a conferencing system assembly includes a screen having a viewing surface and coupled to a structural member and a sensor assembly. The sensor assembly is coupled to the screen and the structural member. The sensor assembly includes a frame and a camera assembly. The frame has a front surface aligned with the viewing surface of the screen and faces towards a detection region. The frame also includes a camera assembly aperture disposed through the front surface. The camera assembly is aligned with the camera assembly aperture and is coupled to the frame. The camera assembly includes a camera sensor defining a sensor orientation vector and a camera actuator coupled to the frame. The camera actuator is configured to translate the camera sensor and orient the sensor orientation vector towards the detection region. The sensor assembly further includes a first microphone assembly coupled to the front surface of the frame and facing the detection region and a second microphone assembly coupled to a back surface of the frame and facing away from the detection region. The first microphone assembly includes a first microphone and a second microphone.

In another embodiment, a conferencing system assembly includes a base having a front surface that faces a detection region, a camera assembly coupled to the base, a front microphone assembly, and a rear microphone assembly. The camera assembly includes a camera sensor defining detection vector and a camera actuator configured to adjust a position of the camera sensor and detection vector relative to the base. The front microphone assembly is coupled to the front surface and is directed towards the detection region. The front microphone assembly includes a first front microphone and a second front microphone. The rear microphone assembly is directed towards a rear zone. The detection region and the rear zone are on opposite sides of the base.

In another embodiment, a method includes detecting, by use of a plurality of microphones, an audible input from an input source, determining, by a controller, a direction of the audible input source based on a difference in time that two or more microphones of the plurality of microphones detected the audible input, generating, by use of an orientation sensor that is coupled to a camera sensor of a video conference assembly, an orientation signal, and using a camera actuator coupled to the camera sensor and a supporting structure of the video conference assembly to orient the camera sensor. The camera sensor is oriented towards the input source based on the determined direction and the orientation signal.

In another embodiment, a method includes determining, by use of an orientation sensor, a screen orientation of a screen by comparing an orientation sensor signal generated by the orientation sensor to a first threshold value stored in memory, determining a camera sensor orientation using an encoder coupled to the camera sensor, the camera sensor orientation determined based on an encoder signal generated by the encoder, and adjusting the orientation of the camera sensor relative to the screen based on the encoder signal.

In another embodiment, a method includes comparing an orientation signal from an orientation sensor with orientation information stored in a memory of a controller coupled to a camera sensor to determine an orientation of the camera sensor, generating, by a camera sensor, an optical signal based on an optical input detected from within a detection region of the camera sensor, wherein the optical signal comprises video information that is oriented in a first orientation, and forming, by the controller, a video signal that comprises the video information, wherein the video information in the video signal is oriented in a second orientation that is different from the first orientation.

In another embodiment, a conferencing system assembly includes a structural member, a screen assembly coupled to the structural member, and a dampening system coupled to the structural member and the screen assembly. The structural member includes a support structure that defines an axis of rotation and a spring mount. The screen assembly is configured to translate between a first orientation and a second orientation about the axis of rotation. The screen assembly includes a center of mass offset from the axis of rotation. The dampening system includes a screen mounting structure disposed between the axis of rotation and the center of mass and a resistive element coupled to the screen mounting structure and the spring mount, wherein the dampening system establishes a neutral orientation of the screen assembly when the screen assembly is in a third orientation between the first orientation and the second orientation.

In another embodiment, a conferencing system assembly includes a structural member, a screen assembly, and a dampening system coupled to the structural member and the screen assembly. The structural member includes a first support mount, a second support mount, an axis of rotation, and a spring mount. The screen assembly is disposed offset from the axis of rotation and includes a screen, and a screen mounting structure disposed opposite from the screen. The dampening system includes a plurality of offset disc assemblies rigidly connected to the screen assembly. Each offset disc assembly of the plurality of offset disc assemblies includes an offset disc disposed around the axis of rotation, a connector link coupled to a connection point of the offset disc, the connection point disposed radially outward from the axis of rotation and opposite the screen assembly, and a tension spring coupled to the connector link and the spring mount, the tension spring configured to bias the connection point toward the spring mount.

In another embodiment, a conferencing system assembly includes a structural member comprising support mounts that are coupled to a rod and a spring mounts, screen mounting structure coupled to the rod, and a dampening system. The dampening system includes an offset disc rigidly connected to the rod and a spring having a first end coupled to a spring connection point of the offset disc and a second end coupled to the spring mount of the structural member. The spring connection point is offset from an axis of rotation of the rod by a first distance. The dampening system is configured to dampen a movement of the screen mounting structure as the screen mounting structure rotates about the axis of rotation of the rod.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only exemplary embodiments and are therefore not to be considered limiting of its scope, for the described embodiments may admit to other equally effective embodiments.

FIG. 1A is a perspective view of a conferencing system assembly, according to one or more embodiments of the present disclosure.

FIG. 1B is a perspective view of a conferencing system assembly, according to one or more embodiments of the present disclosure.

FIG. 1C is a perspective view of a conferencing system assembly, according to one or more embodiments of the present disclosure.

FIG. 1D includes front isometric exploded view of a conferencing system assembly, according to one or more embodiments of the present disclosure.

FIG. 2 is a perspective view of a conferencing system assembly within an environment, according to one or more embodiments of the present disclosure.

FIGS. 3A-3C are side views of a conferencing system assembly during different stages of a reorientation operation, according to one or more embodiments of the present disclosure.

FIG. 4A is a top front right side perspective view of a sensor assembly, according to one or more embodiments of the present disclosure.

FIG. 4B is a top rear right side perspective view of a sensor assembly, according to one or more embodiments of the present disclosure.

FIG. 5 is a top front right side perspective view of a camera assembly, according to one or more embodiments of the present disclosure.

FIG. 6A is a front view of a camera assembly, according to one or more embodiments of the present disclosure.

FIG. 6B is a bottom view of a camera assembly, according to one or more embodiments of the present disclosure.

FIG. 6C is a right side view of a camera assembly in a first orientation, according to one or more embodiments of the present disclosure.

FIG. 6D is a right side view of a camera assembly in the first orientation, according to one or more embodiments of the present disclosure.

FIG. 6E is a right side view of a camera assembly in a second orientation, according to one or more embodiments of the present disclosure.

FIG. 6F is a front view of a camera assembly, according to one or more embodiments of the present disclosure.

FIG. 6G is a front view of a camera assembly, according to one or more embodiments of the present disclosure.

FIG. 7A, is a right side view of a camera assembly, according to one or more embodiments of the present disclosure.

FIG. 7B is a right side view of a camera assembly, according to one or more embodiments of the present disclosure.

FIG. 7C is a right side view of a camera assembly, according to one or more embodiments of the present disclosure.

FIG. 7D is a right side view of a camera assembly, according to one or more embodiments of the present disclosure.

FIG. 8 is a schematic diagram illustrating a sensor assembly, according to one or more embodiments of the present disclosure.

FIG. 9 illustrates a method of determining an orientation of a sensor assembly relative to a screen, according to one embodiment of the present disclosure.

FIG. 10 illustrates a method of determining an orientation of a sensor assembly relative to a screen, according to one embodiment of the present disclosure.

FIG. 11 illustrates a method of determining a direction from which a sound input is received and a noise input based on the direction of the sound input, according to one embodiments of the present disclosure.

FIG. 12A is a perspective view of a video conference assembly, according to one or more embodiments of the present disclosure.

FIG. 12B is a top view of a video conference assembly, according to one or more embodiments of the present disclosure.

FIG. 13 illustrates a method of orienting a camera sensor while suppressing audible noise, according to one embodiments of the present disclosure.

FIG. 14A is a front isometric view of a conferencing system assembly, according to one or more embodiments of the present disclosure.

FIG. 14B is a back isometric view of a conferencing system assembly, according to one or more embodiments of the present disclosure.

FIGS. 15A and 15B are schematic views of a dampening system according to one or more embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

In the following description, numerous specific details are set forth to provide a more thorough understanding of the embodiments of the present disclosure. However, it will be apparent to one of skill in the art that one or more of the embodiments of the present disclosure may be practiced without one or more of these specific details. In other instances, well-known features have not been described in order to avoid obscuring one or more of the embodiments of the present disclosure.

Embodiments of the disclosure generally include methods and apparatuses for meeting and conferencing activities using a conferencing system assembly that can include a display assembly and/or a sensor assembly. The conferencing system assembly may include the sensor assembly which is configured to reorient one or more components, such as a camera assembly in response to translation and/or reorientation of the conferencing system assembly. The sensor assembly may also detect and separate unwanted external noise received from an audible source during a conferencing activity. Embodiments of the disclosure may include a camera assembly that is able to display graphic information when not actively detecting inputs. Embodiments of the disclosure may also include a camera assembly that transmits signals in the proper orientation after determining the camera assembly's location relative to a screen of the conferencing system assembly.

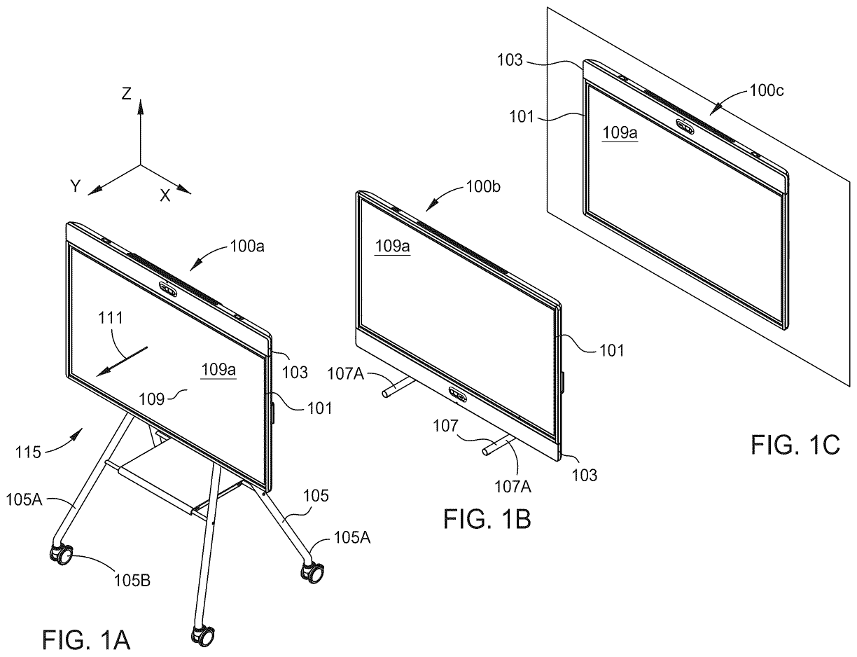

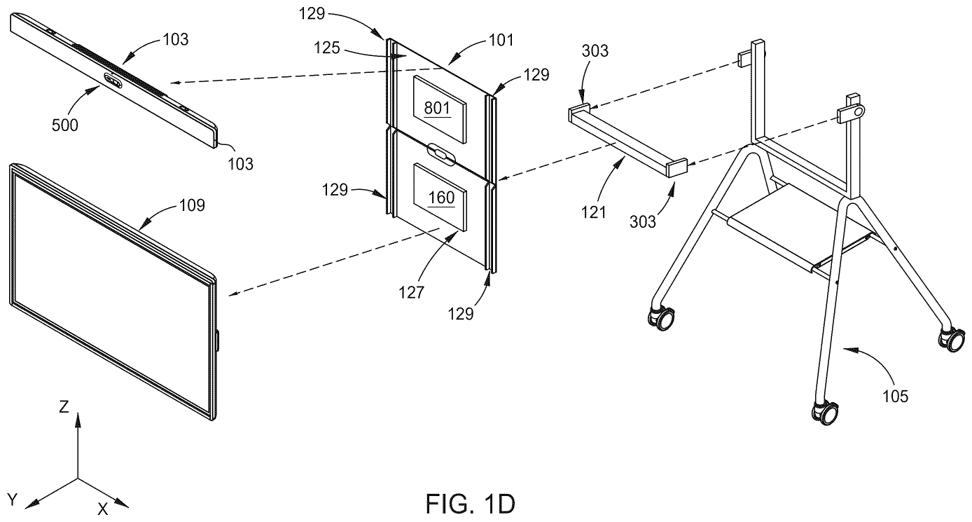

FIG. 1A is a perspective view of a conferencing system assembly 100a, according to one or more embodiments of the present disclosure. FIG. 1B is a perspective view of a conferencing system assembly 100b in a table or desk mount configuration, according to one or more embodiments of the present disclosure. FIG. 1C is a perspective view of a conferencing system assembly 100c in a wall mounted configuration, according to one or more embodiments of the present disclosure.

In each of, the conferencing system assembly 100a as shown in FIG. 1A, the conferencing system assembly 100b as shown in FIG. 1B, and the conferencing system assembly 100c as shown in FIG. 1C, include a structural member 101, a sensor assembly 103, and a screen assembly 109. The conferencing system assembly 100a, shown in FIG. 1A, is mounted on a moveable frame 105. As shown in FIG. 1B, the conferencing system assembly 100b is mounted on a stand 107. As shown in FIG. 1C, the conferencing system assembly 100C is mounted on a wall by use of wall mounting components (not shown) that are configured to support the conferencing system assembly 100C on a wall.

FIG. 1D includes a front isometric exploded view of a conferencing system assembly 100, which is configured as a conferencing device assembly 100a illustrated in FIG. 1A. However, a conferencing system assembly 100 can be configured, for example, for use in anyone of the conferencing device assemblies 100a, 100b, 100c illustrated in FIGS. 1A, 1B, and 1C, respectively. In general, a conferencing system assembly 100, which can be used in any of the configurations disclosed herein, includes the structural member 101 having a screen mounting structure 127 that is configured to support, retain, and couple the screen assembly 109 to the structural member 101. The screen assembly 109 includes a screen 115 configured to display an image thereon. The structural member 101 of the conferencing system assembly 100 also includes a sensor assembly mounting structure 125 that is configured to support, retain and couple the sensor assembly 103 to the structural member 101. The structural member 101 also includes a mounting assembly 121 that is configured to allow the conferencing system assembly 100 of a conferencing device assembly to be mounted on a desired supporting structure, such as the moveable frame 105 (FIG. 1A), the stand 107 (FIG. 1B), or a wall mounting components (not shown). The structural member 101 includes a connection panel 160 and a controller 801. The connection panel 160 includes cable ports for connecting AC power cables, XLR cables, Category cables, USB cables, HDMI cables, or other useful types of cables. The cable ports connect the conferencing system assembly 100a to one or more of a power source, an external monitor, an Ethernet network cable, and a sound system (not shown). The cable ports are connected to the controller 801 for electronic communication. As will be discussed further below, the controller 801 enables orientation and position determinations of sensors and input sources in an environment and utilizes the determinations to enhance conferencing activities.

The structural member 101 can include a structural material such as a metal (e.g., aluminum (Al), coated plain steel, stainless steel (SST), etc.), plastic or other useful load bearing material that can be formed into a structural shape to support the screen assembly 109 and the sensor assembly 103. The structural member 101 will include mounting points 129 that are positioned to mate with mating mounting points within the screen mounting structure 127, sensor assembly mounting structure 125, and mounting assembly 121 to enable the attachment of portions of the screen assembly 109, sensor assembly 103 and mounting components within the mounting assembly 121 to the structural member 101 by use of one or more fasteners.

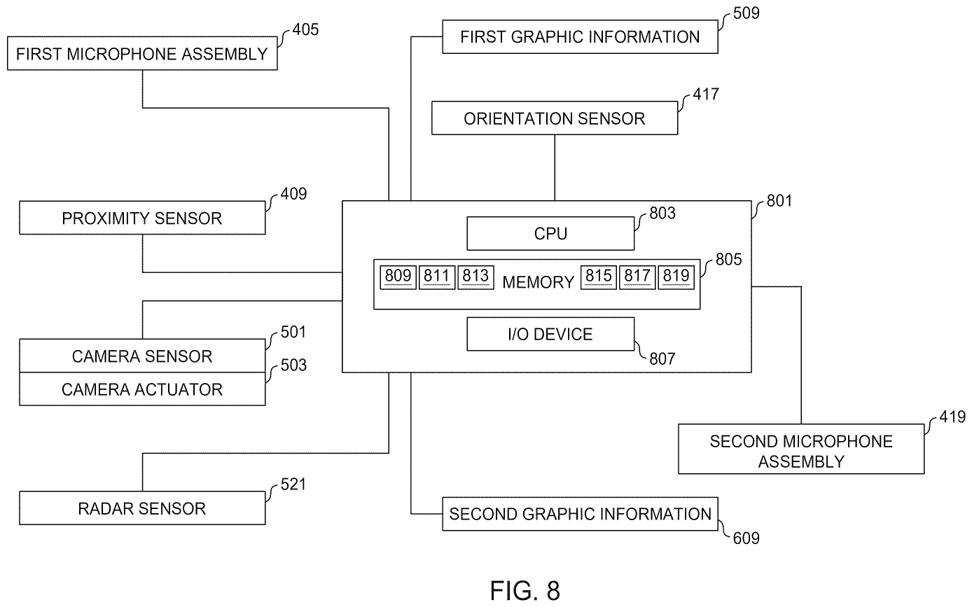

The structural member 101 will also include a plurality of cable routing features, such as channels or ports that are used to aid in the easy connection and management of the cables (e.g., AC power cables, Category cables, USB cables, HDMI cables, etc.) that are used to connect the screen assembly 109 to the controller 801, and components within the sensor assembly 103 to the controller 801. The structural member 101 will also include a plurality of cable routing features that are configured to retain cabling used to connect the controller 801 to an external electrical source (not shown) and/or one or more external electrical devices (e.g., speakers, video conference equipment, computer, etc.). In some embodiments, a conferencing system assembly 100 is configured to only include a single external connection that essentially includes a power cable that is used to provide power to the electrical components positioned within the conferencing system assembly 100. In this configuration the controller 801 will also include one or more wireless transceivers 819 (FIG. 8) that are configured to transfer signals to one or more external devices by use of a wireless communication link, such as by use of a signal transfer method that can include, but is not limited to, wireless communication technologies, such as Bluetooth® wireless technology (BT), Bluetooth® Low Energy wireless technology (BLTE), Infrastructure Wireless Fidelity (Wi-Fi™) wireless technology, soft access point (AP), Wi-Fi-Direct, ultrasonic emitter, near-field communication (NFC), or any combination of the above.

The screen assembly 109 is disposed within and/or coupled to the structural member 101. The screen assembly 109 will include a viewing surface 109a that is used to provide visual information to a user positioned in front of the screen assembly 109. The screen assembly 109 can include a television, monitor, or other similar display device. In some embodiments, the screen assembly 109 includes an LED display, OLED display, QLED display, LCD display, plasma display, or CRT type of display. In some embodiments, the screen assembly 109 is a pre-manufactured television or monitor that includes a display panel (e.g., TFT LCD, plasma, LED, or OLED panels), supporting display screen electronics (e.g., display processor, memory, and other display hardware for rendering images on the display screen), and/or input/output connection points mounted to the screen assembly's supporting structure. In some other embodiments, screen assembly 109 includes the display panel (i.e., image generating component), while the supporting display screen electronics and input/output connection points are formed as components within the controller 801. In this configuration, the image rendering components required by the display panel are separate from the other electrical components of the controller 801, which are described further below.

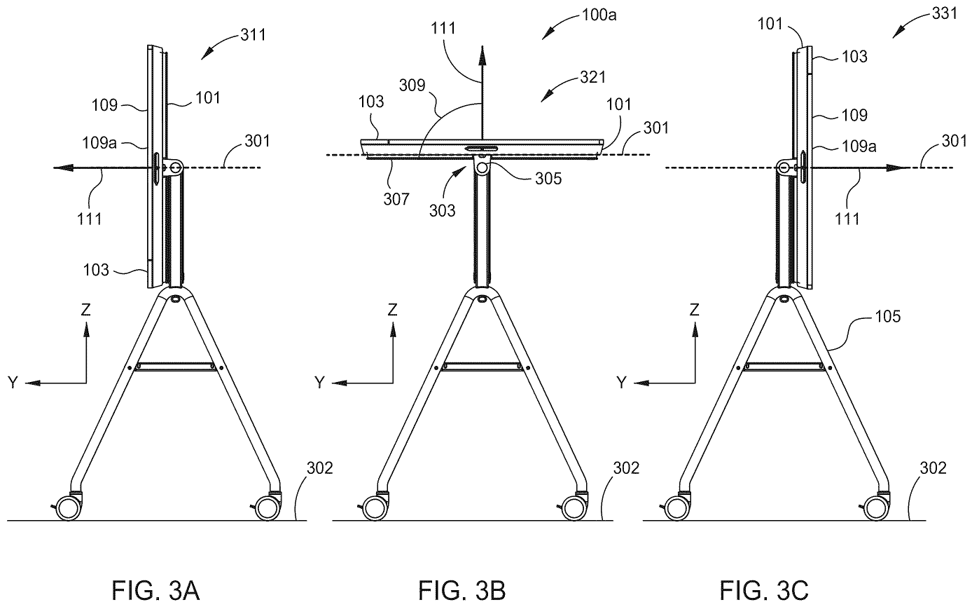

As noted above, the sensor assembly 103 is coupled to the structural member 101. The sensor assembly 103 can be mounted on the structural member 101 in various positions that are adjacent to the viewing surface 109a of the screen assembly 109, such as above or below the screen assembly 109 that is positioned in a first orientation (i.e., the viewing surface 109a is facing a first direction). The viewing surface 109a of the screen assembly 109 includes a display plane that has a display vector 111 that is positioned normal to the viewing surface 109a. Once the sensor assembly 103 is mounted on the structural member 101, the orientation of the sensor assembly 103 relative to the screen assembly 109 can be dynamically adjusted, such that the sensor assembly 103 is positioned above or below the screen assembly 109, by rotating the structural member 101 about an axis of rotation 305 of a hinge 303 (FIGS. 3A-3C).

The movable frame 105, as seen in FIG. 1D, is coupled to the structural member 101, opposite of the screen assembly 109. The movable frame 105 will include a plurality of legs 105A and casters 105B that support and allow the conferencing system assembly 100a to be repositioned within an environment. The stand 107, as seen in FIG. 1B, is coupled to the structural member 101, opposite of the screen assembly 109. Stand 107 will include a plurality of supporting legs 107A that are used to support the conferencing system assembly 100b on a supporting structure, such as a table (not shown), shelf (not shown), or floor positioned within an environment.

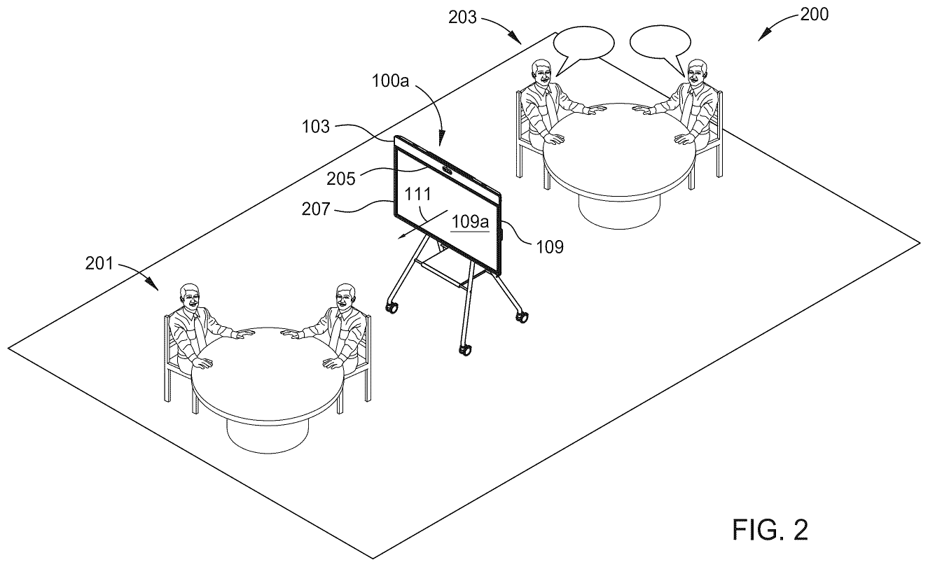

FIG. 2 illustrates one configuration in which the conferencing system assembly 100a is disposed within an environment 200. The environment 200 is an open environment that includes a target meeting 201 and a secondary meeting 203 that are both positioned within different areas of the open space. The conferencing system assembly 100a is directed and oriented toward the users that are a part of the target meeting 201. The conferencing system assembly 100a is oriented such that the viewing surface 109a and display vector 111 of the screen assembly 109 is directed toward the target meeting 201. The secondary meeting 203 is positioned a distance away from the target meeting 201 and the conferencing system assembly 100a is disposed between the secondary meeting 203 and the target meeting 201.

In some embodiments, the viewing surface 109a includes a first edge 205 and a second edge 207. The first edge 205 is aligned at an angle (e.g., 90°) to the second edge 207. For example, the first edge 205 is about perpendicular to the second edge 207. In some embodiments, the sensor assembly 103 is coupled to the first edge 205 and the first edge 205 is a horizontal edge that extends a first length across the surface 109a and the second edge 207 is a vertical edge that extends a second length across the surface 109a, the second length being less than the first length. For example, the first edge 205 is a long edge at the first length and the second edge 207 is a short edge at the second length and the first length and second length have a ratio of about 4:3 to about 21:9, for example, a ratio of about 16:9 between the first edge 205 and the second edge 207.

As will be discussed further below, the sensor assembly 103 is capable of detecting audible inputs and visual inputs generated during the target meeting 201 while filtering out audible inputs from the secondary meeting 203. Components within the sensor assembly 103 are configured to form signals that include information received from the various inputs that are then provided to the controller 801 (FIG. 8) for use in the control of or communication with one or more of the components within the conferencing system assembly 100a. The signals, which are also referred to herein as communication signals, may be audible signals, video signals, optical signals, sensor signals, or a combination thereof that are generated from video inputs, optical inputs, audible inputs, sensor inputs, or a combination thereof.

The sensor assembly 103 is capable of determining an orientation of the conferencing system assembly 100a. The sensor assembly 103 is also able to determine and form a relationship between the detected audible inputs and video inputs in relation to the orientation of the conferencing system assembly 100a. In one conferencing example, the relationship between the detected inputs and the orientation of the conferencing system assembly 100a allows the sensor assembly 103 to arrange generated audible signals and video signals in a proper orientation while undesired noise provided from the secondary meeting 203 is filtered out prior to the audible signals and video signals being displayed by the conferencing system assembly 100a and/or transmitted to an external electronic device (e.g., video equipment in an external video conferencing environment) by use of a communication link.

FIGS. 3A-3C illustrate side views of the conferencing system assembly 100a during a reorientation operation, according to one or more embodiments of the present disclosure. The conferencing system assembly 100a is shown as it translates from a first screen orientation 311 (FIG. 3A), a second screen orientation 321 (FIG. 3B), and a third orientation 331 (FIG. 3C). The structural member 101 of the conferencing system assembly 100a includes a hinge 303 that is formed within the mounting assembly 121, which allows the structural member 101 of the conferencing system assembly 100a to rotate about an axis of rotation 305 that is aligned with the −X-direction. The hinge 303 is coupled to the structural member 101 by a mounting bracket 307. In some embodiments, the hinge 303 includes a hinge encoder (not shown) that transmits a signal to the controller 801 that includes information relating to the angular position of the hinge 303 and movable frame 105 relative to the bracket 307 and the structural member 101. For example, the angular position enables the controller 801 to determine an amount the screen assembly 109 has rotated about the axis of rotation 305. The mounting bracket 307 is coupled to the structural member 101 on a side that is opposite to a side that the screen assembly 109 is positioned on. The hinge encoder of the hinge 303 is able to detect the position of the screen assembly 109 and structural member 101 at an instant in time, and, by use of the controller 801 (FIG. 8), to determine changes in the orientation of the structural member 101 relative to the movable frame 105 and/or by knowledge of the orientation of the orientation sensing portion of the hinge encoder to a reference plane 301 determine the angular position of the structural member 101 relative to the reference plane 301. For example, when the conferencing system assembly 100a is disposed on a planar surface, such as a floor 302 within an environment, the reference plane 301 is a plane about parallel with the floor 302.

In some embodiments and as shown, the axis of rotation 305 is shown parallel with the X-axis and the screen orientation angle 309 is defined by the angle between the positive Y-axis and the display vector 111. As shown in FIG. 3A, in the first screen orientation 311, the screen assembly 109 is disposed above the sensor assembly 103. As the conferencing system assembly 100a rotates about the axis of rotation 305 into the second screen orientation 321, as shown in FIG. 3B, the screen assembly 109 and the sensor assembly 103 are aligned parallel to a horizontal plane (e.g., X-Y-plane). In some embodiments, the conferencing system assembly 100a is defined as being positioned in the first screen orientation 311 when the display vector 111 is within a first orientation threshold, which is defined by the display vector 111 being oriented at least in a first angular orientation relative to a reference plane 301 (e.g., floor of the environment). For example, the first screen orientation 311 is when the screen orientation angle 309 is less than 90° relative to the reference plane 301. In one example, as shown in FIG. 3A, the display vector 111 is parallel to the reference plane 301 and thus the screen orientation angle 309 is about zero (0°) degrees. The screen orientation angle 309 is in the second screen orientation 321 when the display vector 111 is oriented at so that the screen orientation angle 309 is about 90° to the reference plane 301, as shown in FIG. 3B, such that the display vector 111 is about parallel to the Z-axis.

In the third orientation 331, the screen orientation angle 309 is outside the first threshold. In some embodiments, the screen orientation angle 309 is outside of the first threshold when the screen orientation angle 309 is greater than 90° relative to the reference plane 301, when measured in a clockwise direction about the axis of rotation 305 from the reference plane. In some embodiments, the third orientation 331 is when screen assembly 109 is disposed below the sensor assembly 103. If the conferencing system assembly 100a is rotated about the axis of rotation 305 while the movable frame 105 is stationary, the direction of the display vector 111 in the first screen orientation 311 will be opposite the direction of the display vector 111 in the third orientation 331. In one example, as shown in FIGS. 3A and 3C, the viewing surface 109a in the first screen orientation 311 and the third orientation 331 are both aligned in a perpendicular orientation to the reference plane 301 and a parallel relationship to a vertical plane (not shown).

However, in some embodiments, the movable frame 105 includes wheels that enable the conferencing system assembly 100a to translate and align the display vector 111 in the first screen orientation 311 with the display vector 111 in the third orientation 331 without the need to change the orientation of the conferencing system assembly 100a relative to the axis of rotation 305 (i.e., rotate the conferencing system assembly 100a that is in the first orientation and frame 105 about the Z-axis). In this configuration, the relationship of screen assembly 109 and the sensor assembly 103 to the reference plane 301 remains unchanged (e.g., screen assembly 109 is disposed below the sensor assembly 103 in both configurations).

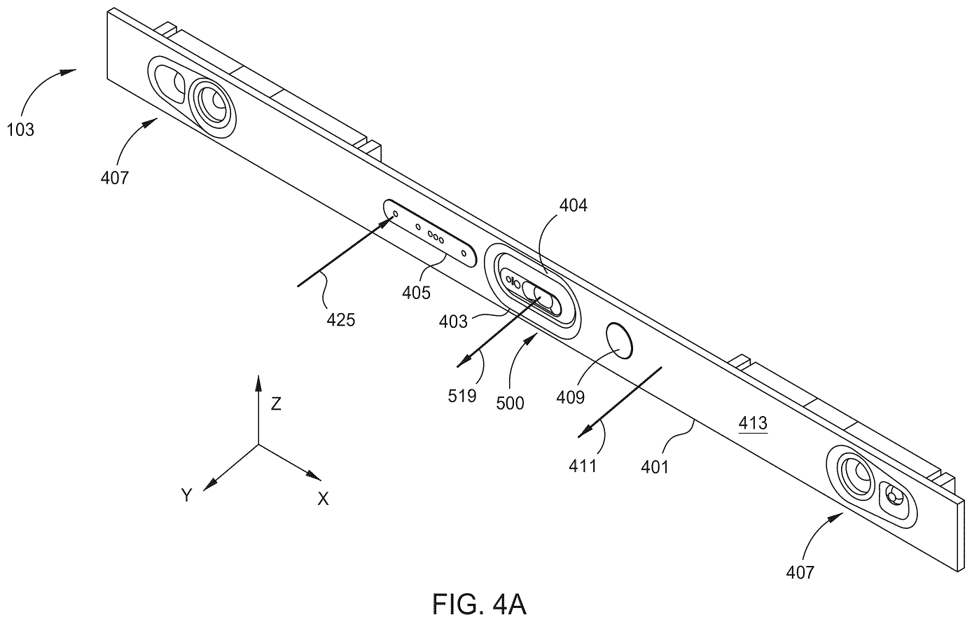

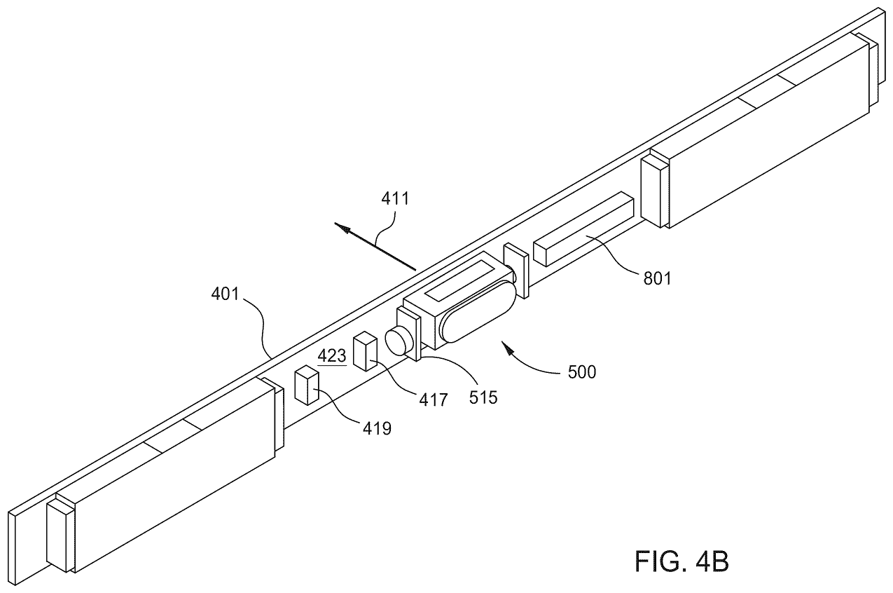

FIG. 4A is a top front right side perspective view of the sensor assembly 103, according to one or more embodiments of the present disclosure. The sensor assembly 103 includes a frame 401, a camera assembly aperture 403 disposed through the frame 401, a first microphone assembly 405, one or more speakers 407, a proximity sensor 409, and a camera assembly 500 (FIG. 4B). The frame 401 includes a front surface 413. The front surface 413 defines a sensor assembly plane. In some embodiments, the frame 401 is coupled to the structural member 101 (FIG. 3A), and the first microphone assembly 405, one or more speakers 407, the proximity sensor 409, the second microphone assembly 419 (FIG. 4B), and the camera assembly 500 are each coupled to a portion of the frame 401. In some embodiments, the front surface 413 is aligned with and about parallel to the viewing surface 109a (FIG. 2).

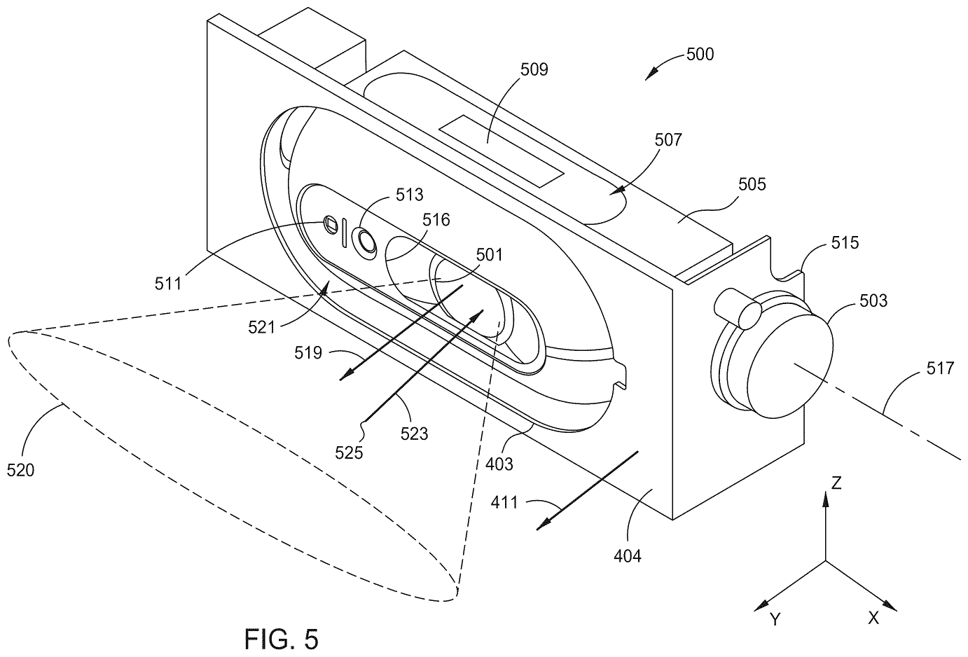

The camera assembly 500 includes a camera sensor 501 (FIG. 5) that has a sensor orientation vector 519 (FIG. 5). As shown in FIG. 5, the sensor orientation vector 519 is about parallel to a detection vector 411. Referring back to FIG. 4A, the detection vector 411 is the direction the sensor assembly 103 and camera assembly 500 faces. The sensor orientation vector 519 is adjustable based on the controlled movement of the camera body 505 (FIG. 5) by an actuator 503 (FIGS. 4B and 5) by use of commands from the controller 801. In one example, the detection vector 411 is directed toward the target meeting 201 (FIG. 2). The sensor orientation vector 519 is positioned at a center of a field-of-view (FOV) of the camera sensor 501. As shown in FIG. 4A, the detection vector 411 of the camera assembly 500 is aligned perpendicular to the front surface 413 and aligned with the opening of the camera assembly aperture 403. The actuator 503 is configured to position the camera sensor within the camera assembly aperture when the camera body is positioned in a first orientation about a camera axis of the camera body. The actuator 503 is configured to position the camera sensor 501 in a second orientation when the camera body 505 is positioned in a second orientation about camera axis 517 of the camera body 505. The actuator 503 is configured to position the camera sensor 501 in a third orientation when the camera body 505 is positioned in a third orientation about camera axis 517 of the camera body 505. The second and third orientations are aligned in opposing directions.

The camera assembly aperture 403 includes a cover 404. When the camera sensor 501 is not in use, the actuator 503 of the camera assembly 500 rotates the camera sensor 501 so the camera sensor 501 is hidden behind the cover and the sensor orientation vector 519 is not positioned to extend through the camera assembly aperture 403. The camera sensor 501 detects video related input information through the camera assembly aperture 403 of the front surface 413. The camera sensor 501 can include an electronic optical image sensor, such as a charge-coupled device (CCD) sensor, the active-pixel sensor (CMOS sensor), or other type of image sensor that is used to form a single electronic image or streams of electronic images to, for example, form a video stream.

The sensor assembly 103 will be disposed with the detection vector 411 directed toward the target meeting 201 (FIG. 2) and the camera assembly 500 orients the camera sensor 501 so the sensor orientation vector 519 towards the target meeting 201 when in use and then rotates the camera sensor 501 so the sensor orientation vector 519 is behind the cover 404 when not in use.

The first microphone assembly 405 is disposed on and coupled to the front surface 413 of the frame 401. The first microphone assembly 405 includes one or more microphones capable of detecting audible inputs. Each of the microphones can include a condenser microphone capsule or a dynamic microphone (e.g., voice-coil microphone). In some embodiments, the first microphone assembly 405 includes a first front microphone and a second front microphone. In one configuration, the first microphone assembly 405 includes a linear array of microphones. In one configuration, the camera sensor 501 is positioned between a first front microphone and a second front microphone. The audible inputs received by the first microphone assembly 405 can include a conference input 425, such as audible inputs provided by participants within a video conference. The audible inputs may be received by the first microphone assembly 405 in a direction substantially opposite from the detection vector 411. In one example, the first microphone assembly 405 is configured to receive the conference input 425 from the target meeting 201 (FIG. 2).

The proximity sensor 409 is disposed on the front surface 413 of the frame 401. In some embodiments, the proximity sensor 409 includes an infrared (IR) sensor that enables the detection of objects, such as one or more human bodies disposed within the detection region of the proximity sensor 409. In some embodiments, the proximity sensor 409 is an IR sensor directed in a direction that is parallel to the detection vector 411.

FIG. 4B is a top rear right side perspective view of the sensor assembly 103, according to one or more embodiments of the present disclosure. FIG. 4B illustrates a back view of the sensor assembly 103. As shown in FIG. 4B, the sensor assembly 103 includes the camera assembly 500, an orientation sensor 417 coupled to a back surface 423 of the frame 401, and a second microphone assembly 419. In some configurations, the controller 801 is optionally disposed within the sensor assembly 103, while in other configurations, as shown in FIG. 1D, the controller 801 is coupled to the structural member 101. The frame 401 is a supporting structure that is configured to support the camera assembly 500, the orientation sensor 417, and the second microphone assembly 419. Frame 401 can include a structural material such as a metal (e.g., aluminum (Al), coated plain steel, stainless steel (SST), etc.), plastic, or other useful load-bearing material that can be formed into a structural shape to support the components within the sensor assembly 103.

The first microphone assembly 405, the second microphone assembly 419, the proximity sensor 409, the orientation sensor 417, and the camera assembly 500 are in electronic communication with the controller 801. The first microphone assembly 405, the second microphone assembly 419, the proximity sensor 409, the orientation sensor 417, and/or the camera assembly 500 detect inputs, and convert those inputs into signals, which are transmitted back and forth between the controller 801 and the various components within the conferencing system assembly 100.

As shown in FIG. 4B, the second microphone assembly 419 is coupled to the back surface 423 of the frame 401. In some embodiments, the second microphone assembly 419 is disposed on a side of the front surface 413 or positioned to face a direction that is opposite from the side that the first microphone assembly 405 is disposed or positioned to face. In one example, the second microphone assembly 419 is disposed on an opposite side of the sensor assembly 103 from the first microphone assembly 405. The second microphone assembly 419 detects inputs from an opposite direction of the detection vector 411. The controller 801 receives signals from the first microphone assembly 405 and the second microphone assembly 419. The controller 801 compares the signals and uses the signals from the second microphone assembly 419 to filter noise out of the signal from the first microphone assembly 405. In one example, the first microphone assembly 405 detects the conference input 425 and other additional noise input at a time T1 and sends a first audible signal based on the conference input 425 to the controller 801. The second microphone assembly 419 will detect the other additional noise input at a time T2 and transmits a second audible signal based on the detected additional noise input to the controller 801. In one example, the controller 801 compares the first audible signal and the second audible signal to determine a direction of noise input. The controller 801 is able to filter out the noise input from the conference input 425 to form a filtered and/or clean signal. An algorithm of the controller 801, executed by a the processor, is configured to form a filtered signal based on a comparison between a time when a first input is received by the first microphone and a second input is received by the second microphone

The filtered signal may include an audible signal portion and a video signal portion. The video signal portion is the signal transmitted from sensor assembly 103 to the controller 801. In some embodiments, the camera assembly 500 is coupled to the back surface 423 of the frame 401.

The orientation sensor 417 enables the controller 801 to determine the orientation of the sensor assembly 103. In some embodiments, the sensor assembly 103 is rigidly coupled to the conferencing system assembly 100a (FIG. 1A) which enables the controller 801 to determine the orientation of the sensor assembly 103 relative to the conferencing system assembly 100a. In some embodiments, the orientation sensor 417 is a type of sensor that measures the rotational position or orientation of the conferencing system assembly 100 in 3D space by utilizing one or more accelerometers, gyroscopes, and magnetometers to determine the conferencing system assembly's orientation and pitch, roll, and yaw angles relative to a reference frame. The primary types of orientation sensors, such as accelerometers, gyroscopes, and magnetometers can be combined in some cases to achieve accurate orientation data.

FIG. 5 is a perspective view of the camera assembly 500, according to one or more embodiments of the present disclosure. The camera assembly 500 includes the camera sensor 501, a camera actuator 503, a camera body 505, a first graphic region 507 that includes a set of first graphic information 509, a second graphic region 607 that includes a set of second graphic information 609 (not shown in FIG. 5), a first time-of-flight sensor 511, a second first time-of-flight sensor 513, and a bracket 515. The camera body 505 includes a sensor face 516 that defines a plane. The camera sensor 501, the first time-of-flight sensor 511, and the second first time-of-flight sensor 513 are disposed in the plane of the sensor face 516.

The camera sensor 501 is coupled to and/or disposed within the camera body 505. The camera body 505 is coupled to the bracket 515 by use of one or more bearings (not shown), which allow the camera body 505 to rotate about the camera axis, and is coupled to the camera actuator 503. In some embodiments, the camera body 505 is a cylindrical body that is aligned along the camera axis 517. The camera body 505 includes an external surface on which the first graphic region 507 and the second graphic region 607 are positioned.

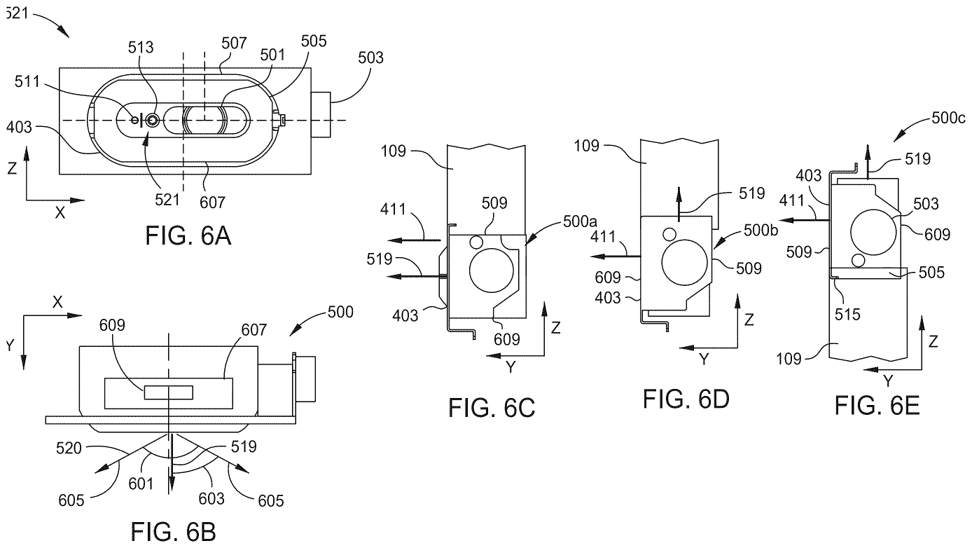

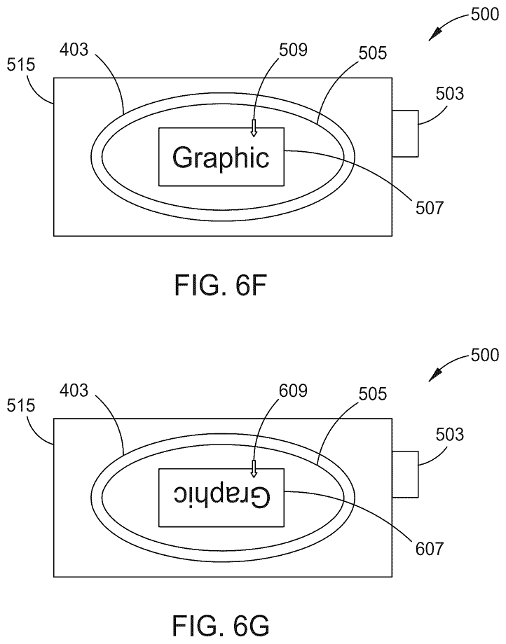

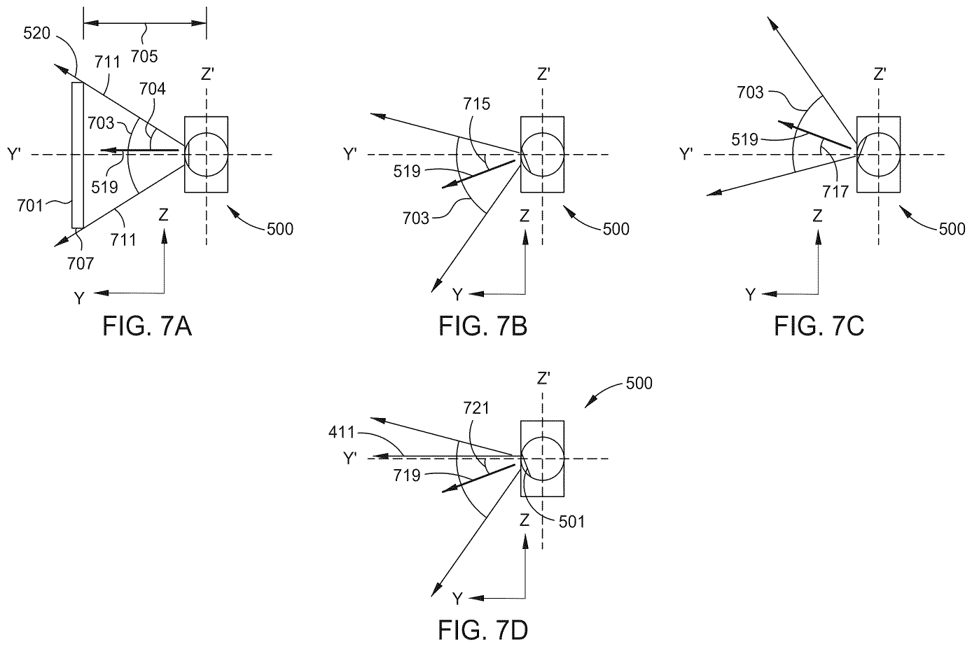

The camera actuator 503 is configured to rotate the camera body 505 about the camera axis 517. In some embodiments, the camera axis 517 is a horizontal axis and is parallel to the X-axis of the co-ordinate system. In some embodiments, the camera axis 517 is parallel to the axis of rotation 305 of the conferencing system assembly 100a (FIGS. 3A-3C). For example, the camera axis 517 is aligned relative to the axis of rotation 305. The sensor orientation vector 519 is perpendicular to the plane of the sensor face 516 of the camera sensor 501. As will be discussed further below, the camera sensor 501 includes a field of view 520 that is aligned with the sensor orientation vector 519. The field of view 520 includes a horizontal component 601 (FIG. 6B) and a vertical component 703 (FIG. 7A). In some embodiments, the sensor orientation vector 519 is disposed in an orientation that is perpendicular to the camera axis 517. The camera actuator 503 rotates the camera body 505 so that the sensor orientation vector 519 can be oriented so that the sensor orientation vector 519 passes through the camera assembly aperture 403. In one example, the sensor orientation vector 519 is directed through the camera assembly aperture 403 to detect visual inputs from the surrounding environment. The camera sensor 501 receives an optical input 523 from a detection direction 525. In some embodiments, the detection direction 525 is opposite the sensor orientation vector 519. The camera actuator 503 is also able to rotate the camera body 505 to display the first graphic information 509 disposed on the first graphic region 507 of the camera body 505 through the camera assembly aperture 403 and toward the surrounding environment. When the first graphic information 509 is displayed through the camera assembly aperture 403, the first graphic information 509 provides a visual indicator that the camera sensor 501 is not detecting inputs from the surrounding environment and/or provide some desired information to a user positioned to view the first graphic region 507 or the second graphic region 607 through the camera assembly aperture 403.

During operation the controller 801 (FIGS. 4B and 8) is configured to transmit signals to the camera actuator 503 to causes the camera actuator 503 to rotate the camera body 505 to display the first graphic information 509, align the camera sensor 501 with the camera assembly aperture 403, or display the second graphic information 609 (FIG. 6B) after determining the proper orientation of the sensor assembly 103 (FIG. 4B) relative to the screen assembly 109 (FIG. 1). In one example, when the conferencing system assembly 100a (FIG. 3A) is in the first screen orientation 311, the controller 801 (FIGS. 4B and 8) causes the camera actuator 503 to translate the camera body 505 to display the first graphic information 509. In some embodiments, the camera sensor 501 is hidden behind the cover 404 in which the camera assembly aperture 403 is formed when either the first graphic information 509 or the second graphic information is positioned within the camera assembly aperture 403. In some embodiments, the camera actuator 503 includes an actuator encoder that is in communication with the controller 801. The controller 801 is able to determine the orientation of the camera actuator 503 and the camera body 505 based on input and signals transmitted between the actuator encoder of the camera actuator 503.

The controller 801 is in electronic communication with the first time-of-flight sensor 511 and the second first time-of-flight sensor 513. In some embodiments, the first time-of-flight sensor 511 is a light emitting diode (LED) emitter and the second first time-of-flight sensor 513 is a camera receiver. In some embodiments, one or both of the first time-of-flight sensor 511 and the second first time-of-flight sensor 513 can be a radar sensor 521. In some embodiments, the radar sensor 521 is an IR sensor that enables the camera sensor 501 to determine a distance between the camera sensor 501 and an object based on an optical input generated by the act of sensing the object positioned within the environment (e.g., participant in a video conference). The optical input can be a real-time input detected and received by the camera sensor 501. In some embodiments, the first time-of-flight sensor 511 and the second first time-of-flight sensor 513 are configured to detect infrared light generated by the participants within the target meeting 201 (FIG. 2). In some embodiments, the radar sensor 521 detects changes in the position and/or changing position of one or more of the objects detected within the environment. The radar sensor 521 converts the detected input into a signal that is transmitted to the controller 801. The controller 801 uses the signal from the radar sensor 521 to cause the camera actuator 503 to orient and/or adjust focal point or FOV of the camera sensor 501 relative to the object. In some embodiments, the controller 801 is configured to determine an occupancy in the environment 200 (FIG. 2) based on the number of different objects detected by the radar sensor 521. The controller 801 is able to orient the camera sensor 501 based on information collect by the radar sensor 521.

FIG. 6A is a front view of the camera assembly 500, according to one or more embodiments of the present disclosure. The camera assembly 500 includes a second graphic region 607 disposed on a side of the camera body 505 opposite from the first graphic region 507. In some configurations, the portion of the external surface of the camera body 505 on which the first graphic region 507 is positioned and the portion of the external surface of the camera body 505 on which the second graphic region 607 is positioned are each an equal distance from the camera axis. The first graphic region 507 and the second graphic region 607 enable the camera actuator 503 to rotate the camera body 505 to display the first graphic information 509 found in the first graphic region 507 or the second graphic information 609 found in the second graphic region 607, depending on which would be viewed in the proper orientation. In one example, the camera actuator 503 is configured to display one of the first graphic information 509 or the second graphic information through the camera assembly aperture 403 based on the input received by the controller 801 from the orientation sensor 417. In one example, the when the conferencing system assembly 100a (FIG. 3C) is in the third orientation 331, the controller 801 (FIG. 4B) is electronically coupled to and is configured to cause the camera actuator 503 to translate the camera body 505 to display a second graphic information 609 (FIG. 6B). In general, the first graphic information 509 and second graphic information 609 can include an image, symbol, graphic, alphanumeric text, or other useful information. In one example, if the first graphic information 509 and the second graphic information 609 were a same alphanumeric text, the alphanumeric text would be displayed in the proper orientation when the first graphic information 509 is positioned in the first screen orientation 311, but the text would be displayed in an inverse orientation if the second graphic information 609 was displayed while still in first screen orientation 311. Described another way, the text of the first graphic information 509 and the second graphic information 609 would appear rotated by about 180° if viewed and displayed in the first screen orientation 311. In this example, the alphanumeric information formed within the first graphic region 507 will be oriented in an opposite orientation from alphanumeric information formed within the second graphic region 607 when comparing the sides of camera body 505 from the same reference frame.

In another example, the first graphic region 507 includes alphanumeric information that is right side up when the camera body 505 is rotated counter clockwise about the axis 517 so that the first graphic region 507 is positioned within the opening of the camera assembly aperture 403 and the conferencing system assembly 100 is positioned in the first screen orientation 311 (FIG. 3A). Similarly, in this example, the second graphic region 607 includes alphanumeric information that is right side up when the camera body 505 is rotated clockwise about the axis 517 so that the second graphic region 607 is positioned within the opening of the camera assembly aperture 403 and the conferencing system assembly 100 is positioned in the third orientation 331 (FIG. 3C). When the first graphic region 507 is first positioned within the camera assembly aperture 403, the camera actuator 503 can then sequentially rotate the camera body 505 about the camera axis 517 to sequentially position the first graphic region 507, the camera sensor 501, and the second graphic region 607 within the camera assembly aperture 403, and then complete a reverse positioning sequence when the camera actuator 503 rotates the camera body 505 in the reverse direction. In one configuration, the first graphic region 507 and the second graphic region 607 are each positioned at a rotation angle substantially equal to or greater than 90° apart from the camera sensor 501 (e.g., ±90°) so that an angular rotation of the camera body 505 of the rotation angle (e.g., 90°) about the camera axis 517 causes the first graphic region 507, the camera sensor 501, or the second graphic region 607 to be sequentially positioned at the same position within the camera assembly aperture 403.

In some embodiments, the first graphic information 509 and the second graphic information 609 are electronic displays that are connected to and in communication with the controller 801. The controller 801 includes programs, that when executed by a processor 803, cause the camera actuator 503 to rotate and display the first graphic information 509 or the second graphic information 609 through the camera assembly aperture 403. The first graphic information 509 or the second graphic information 609 can include an image, symbol, graphic, or alphanumeric information right side up depending on the orientation of the conferencing system assembly 100a.

FIG. 6B is a bottom view of the camera assembly 500, according to one or more embodiments of the present disclosure. The second graphic region 607 includes the second graphic information 609. The second graphic region 607 and the second graphic information 609 are disposed on an opposing surface of the camera body 505 from the first graphic region 507 and the first graphic information 509.

The sensor orientation vector 519 in FIG. 6B illustrates a horizontal component 601 of the field of view 520 (FIG. 5). The horizontal component 601 of the field of view 520 is formed by a horizontal view angle 603 extending from the sensor orientation vector 519 to an outer horizontal field of view 605. The sensor orientation vector 519 bisects the horizontal component 601 of the field of view 520. In some embodiments, the horizontal view angle 603 extends at least 55° from the sensor orientation vector 519, for example the horizontal view angle 603 extends about +/−45° to about +/−75° from the sensor orientation vector 519. In some embodiments, the horizontal component 601 of the field of view 520 is about 100° to about 110°.

FIG. 6C is a right side view of the camera assembly 500, according to one or more embodiments of the present disclosure. The camera assembly 500 is in a first orientation 500a when the sensor orientation vector 519 is closer to about parallel with the Y axis than the Z axis and the screen assembly 109 is disposed above the camera assembly 500. When the controller 801 places the sensor assembly 103 in a conference mode, the camera actuator 503 disposes the camera assembly 500 in the first orientation 500a such that the sensor orientation vector 519 of the camera sensor 501 is directed through the camera assembly aperture 403 and about parallel with the display vector 111.

As shown in FIG. 6C, when the sensor assembly 103 is in the first orientation 500a, the first graphic information 509 is facing the positive Z-axis and the second graphic information 609 is about parallel with the negative Z-axis.

FIG. 6D is a right side view of the camera assembly 500, according to one or more embodiments of the present disclosure. The camera assembly 500 is in a second orientation 500b when the sensor orientation vector 519 is parallel with the positive Z-axis, the second graphic information 609 is visible through the camera assembly aperture 403, the screen assembly 109 is disposed above the camera assembly 500, and the first graphic information 509 is facing towards the negative Y-axis.

FIG. 6E is a right side view of the camera assembly 500, according to one or more embodiments of the present disclosure. The camera assembly 500 is in a third orientation 500c when the sensor orientation vector 519 is parallel with the positive Z-axis, the first graphic information 509 is visible through the camera assembly aperture 403 and the second graphic information 609 is facing the negative Y-axis.

FIGS. 6D and 6E illustrate examples of when the camera assembly 500 is placed in a standby mode. When in the standby mode, the camera actuator 503 translates the camera assembly 500 to dispose the first graphic information 509 (FIG. 6E) or the second graphic information 609 (FIG. 6D) to face the along the display vector 111. When the sensor assembly 103 is in the standby mode the controller 801 determines which graphic information to display based on an input from the orientation sensor 417.

In some embodiments, the proper orientation is defined by how the first graphic information 509 and the second graphic information 609 would appear when viewed through the camera assembly aperture 403. In one example, the first graphic information 509 and the second graphic information 609 are both the same graphic, but when viewed through the camera assembly aperture 403, only one of the first graphic information 509 or the second graphic information 609 is right side up while the other would be upside down.

In some embodiments, the first graphic information 509 and the second graphic information 609 form an ambigram. In one example, the first graphic information 509 and the second graphic information 609 form a 180° rotational ambigram, where at least one of the first graphic information 509 or the second graphic information 609 displays one way right-side up and another way upside down. By forming an ambigram with the first graphic information 509 and the second graphic information 609, the controller 801 can dispose the first graphic information 509 or the second graphic information 609 in the proper orientation.

FIGS. 6F and 6G illustrate examples of front views of the camera assembly 500 when in the standby mode. As shown in FIG. 6F, the camera actuator 503 has translated the camera assembly 500 to dispose the first graphic information 509 along the detection vector 411 (FIG. 6C). In this example, the first graphic information 509 is the word “Graphic” and is displayed in the proper orientation. FIG. 6G is the camera assembly 500 from the same view as FIG. 6F but the camera actuator 503 has translated the camera assembly 500 to dispose the second graphic information 609, instead of the first graphic information 509 along the detection vector 411 (FIG. 6C). In the example, the second graphic information 609 is the word “Graphic” and is displayed upside down and in an improper orientation. When the first graphic information 509 and the second graphic information 609 form an ambigram, one of the first graphic information 509 or the second graphic information 609 will be disposed right side up (proper orientation) while the other will be disposed upside down (improper orientation) when viewed from the same direction.

The above described relation between the orientation of the first graphic information 509 and the orientation of the second graphic information 609 enables the camera assembly 500 to disposed a graphic information in a proper orientation in relation to the orientation of the conferencing system assembly 100a (FIG. 3A). The controller 801 detects the orientation of the conference system assembly 100 and causes the camera assembly 500 to display a graphic information in the corresponding proper orientation by detecting the position of the sensor assembly 103 relative to the screen assembly 109. For example, when the conferencing system assembly 100a is in first screen orientation 311 (FIG. 3A) and in the standby mode, the controller 801 determines the first graphic information 509 would be displayed in the proper orientation and instructs the camera actuator 503 to dispose the first graphic information 509 along the display vector 111 (FIG. 3A). As the device assembly 100a rotates from first screen orientation 311 to be disposed in the third orientation 331, the controller 801 determines the second graphic information 609 would be displayed in the proper orientation and instructs the camera actuator 503 to dispose the second graphic information 609 along the display vector 111 (FIG. 3C). While illustrated as the camera assembly 500 and the screen assembly 109 rotating about parallel horizontal axis, in some embodiments, the camera assembly 500 can rotate about a differently oriented axis and the screen assembly 109 can rotate about a horizontal axis because the controller detects relative position between the sensor assembly 103 and screen assembly 109 and is not dependent on external elements. For example, the controller 801 detects the orientation of the conference system assembly 100 relative to the camera assembly 500 and is then able to display a graphic information in the proper orientation by a positional relationship of the screen as opposed to relying on a detected gravitational force.

The above are exemplary orientations of the camera assembly 500 to illustrate that the camera actuator 503 is capable or rotating the camera body 505 within the bracket 515 to display either of the first graphic information 509 or the second graphic information 609. In some embodiments, the first graphic information 509 is the second graphic information 609 after being rotated by 180° so that after the controller 801 has determined the orientation of camera assembly 500, the controller 801 is able to determine which of the first graphic information 509 or the second graphic information 609 will be in the correct orientation, when displayed.

FIGS. 7A, 7B, and 7C are right side views of the camera assembly 500, according to one or more embodiments of the present disclosure. FIGS. 7A, 7B, and 7C each include a fixed reference frame coordinate system that includes a Y′ axis and a Z′ axis bisecting the camera assembly 500. As illustrated in FIG. 7A, the camera assembly 500 includes a focal plane 701 and a vertical component 703 of the field of view 520 (FIG. 5). In some embodiments, the focal plane 701 is disposed at a focal length 705 away from the camera assembly 500. The focal length 705 is between about 10 inches and about 50 feet. The focal plane 701 includes a depth 707. The controller 801 (FIG. 4B) determines how to configure the camera assembly 500 to adjust the focal plane 701, the focal length 705, and the depth 707 of the focal plane 701 to detect video inputs and transmit an in-focus signal. In one example, the radar sensor 521 (FIG. 5) can detect an object disposed about 50 feet away and the camera assembly 500 is able to adjust one or more of the focal plane 701, the focal length 705, and the depth 707 of the focal plane 701 to detect video inputs and transmit an in focus signal. The controller 801 is also able to use detected audible inputs to accurately identify a target input source instead of a noise input source. The use of audible input and visual input detection provides enhanced input identification for an improved conferencing experience.

The vertical component 703 of the field-of-view 520 is defined by an angle 704 from the sensor orientation vector 519 to a vertical outer limit 711. The vertical component 703 of the field of view 520 includes an angle 704 from the sensor orientation vector 519 to the vertical outer limit 711 of the field-of-view.

As illustrated in FIGS. 7B and 7C the camera actuator 503 within the camera assembly 500 is able to orient the sensor orientation vector 519 and thus the field-of-view 520 to positions above and below the Y′ axis. The camera actuator 503 of the camera assembly 500 is able to rotate the sensor orientation vector 519 a counter clockwise angle 715 below the Y′ axis and a clockwise angle 717 above the Y′ axis to expand the camera assembly′ vertical scope of detection. For example, when the conferencing system assembly 100a in in the third orientation 331 (FIG. 3C), the controller 801 may cause the camera assembly 500 to direct the sensor orientation vector 519 below the Y′ axis to adjust the field-of-view 520 to focus on objects below the camera assembly 500. In another example, when the conferencing system assembly 100a is in the first screen orientation 311 (FIG. 3A), the controller 801 may cause the camera assembly 500 to direct the sensor orientation vector 519 above the Y′ axis to focus on objects positioned above the camera assembly 500. In some embodiments, the Y′ axis is parallel to the detection vector 411 (FIG. 4A).

As illustrated in FIG. 7C, the camera assembly 500 is oriented to direct the sensor orientation vector 519 above the Y′ axis. For example, when the conferencing system assembly 100a in the first screen orientation 311 (FIG. 3A), the controller 801 may cause the camera assembly 500 to direct the sensor orientation vector 519 above the Y′ axis to focus on portions of objects that are positioned above the vertical position of the camera assembly 500.

The known or determined relationship between the sensor orientation vector 519, the Y′ axis, and the orientation of the conferencing system assembly 100a by the controller 801 enables the controller 801 to determine the preferred angular position of the sensor orientation vector 519 relative to the Y′ axis, the required the focal length 705, and the depth 707 of the focal plane 701. In some embodiments, the controller 801 is configured to determine and adjust the camera sensor orientation, the sensor orientation vector 519, and the field of view 520 of the camera sensor 501 based on the input from one or more of the radar sensor 521, the first microphone assembly 405, the orientation sensor 417, the second microphone assembly 419, and the proximity sensor 409. The information relating to the determined relationship between the sensor orientation vector 519, the Y′ axis, and the orientation of the conferencing system assembly 100a can be stored in memory of the controller 801 for use by one or more algorithms stored in memory to control the orientation of the camera sensor 501, adjust the information displayed on the screen assembly 109, and/or information transferred to one or more external electronic devices. The information displayed on the screen assembly 109 or transferred to the one or more external electronic devices can include audible information received by the first microphone assembly 405 and the second microphone assembly 419, and video collected by the camera sensor 501.

FIG. 7D is a right side view of the camera assembly 500, according to one or more embodiments of the present disclosure. As shown, the camera assembly 500 has been translated from a preset orientation as shown in FIG. 7A to a user-determined orientation as shown in FIG. 7D. The user-determined orientation is when the camera assembly 500 has been manually translated to a user-set orientation vector 719 at a user-set angle 721. As described herein, manually translated is defined as physical force applied to the camera sensor 501 (FIG. 5) directly by a user, for example, a non-electrically driven force. In yet another example, manually translated includes a user adjusting the orientation of the camera sensor 501 by physically contacting the camera sensor 501 with their hand.

The actuator encoder of the camera actuator 503 (FIG. 5) detects the change in orientation and a controller 801 (FIG. 8) determines the user-set orientation vector 719 and the user-set angle 721 of the user-determined orientation of the camera sensor 501 (FIG. 5).

In some embodiments, once the camera actuator 503 (FIG. 5) translates the camera sensor 501 to the preset orientation (FIG. 7A), the camera actuator 503 releases the camera sensor 501 and stops applying force (e.g., removes a holding current applied to the camera actuator 503) to the camera sensor 501. In some embodiments, when released, the camera sensor 501 is held in place by friction.

In some embodiments, the camera assembly 500 may be manually translated by a user to the user-determined orientation shown in FIG. 7D. The actuator encoder of the camera actuator 503 (FIG. 5) transmits signals to the controller 238. The controller 801 is able to store the user-set orientation vector 719 and the user-set angle 721 in memory 805 of the controller 801. In some embodiments, the controller 801 enables the substitution of the preset orientation shown in FIG. 7A with the user-determined orientation of FIG. 7D.

Storing the user-set orientation vector 719 and the user-set angle 721 enables reduced startup times when the camera assembly 500 changes from a standby mode to an active mode. Changing a default orientation from the preset orientation to the user-determined orientation reduces subsequent adjustment by the user who would otherwise have to set the camera assembly 500 to the user-determined orientation each time the camera assembly 500 changes from the standby mode to the active mode. In some embodiments, the user-set orientation vector 719 and the user-set angle 721 also enable adjustment of orientation the first graphic region 507 and the second graphic region 607 when in standby mode.

FIG. 8 is a schematic diagram illustrating the various system level components that form the controller 801 that can be disposed within the sensor assembly 103, according to one or more embodiments of the present disclosure.

One or more of the embodiments of the disclosure provided herein may be implemented as an algorithm, or also referred to herein as a program product, for use with the various components of the conferencing system assembly 100. The program(s) or algorithm(s) are used to control the various functions (including the methods described herein) that are to be performed by the conferencing system assembly 100 and can be contained on a variety of computer-readable storage media (i.e., memory 805). Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The controller 801 includes the processor 803 that is configured to execute an algorithm or program code to perform one or more desired functions, such as analyzing stored and received information and control the execution of tasks performed by the various components within the conferencing system assembly 100. In one or more embodiments, the processor 803 may comprise an application-specific integrated circuit (ASIC) device, digital signal processor (DSP), a system on chip (SOC), or any other processing unit known in the art. The processor 803 may be a central processing unit (CPU). The memory 805 may be programmed for short term and/or long term memory storage. The memory 805 may comprise one or more program(s) to be executed by the processor 803 disposed within the controller 801. For example, the memory 805 includes one or more of a first program 809, a second program 811, a third program 813, a fourth program 815, and a fifth program 817, each with operations of methods that can be executed by the processor 803. The memory 805 may include both volatile and non-volatile memories.

The controller 801 is configured to communicate with and/or control at least the camera actuator 503, the orientation sensor 417, the hinge encoder of the hinge 303, the camera sensor 501, the proximity sensor 409, the radar sensor 521, the first microphone assembly 405, and the second microphone assembly 419 by use of a plurality of communication links via an I/O device 807 that can be enabled by use of various types of cables. For example, the controller 801 and camera actuator 503 and actuator encoder are able to transmit and receive signals between each other. In some embodiments, the controller 801 is configured to actuate the camera actuator 503 in response to an input from the orientation sensor 417 to adjust the position of the camera sensor 501 relative to the sensor assembly 103 and external reference frame. The controller 801 is configured to determine the orientation of the camera sensor 501 relative of to the screen assembly 109 based on the inputs from one or more of the camera actuator 503, the orientation sensor 417, and the hinge encoder of the hinge 303. For example, as seen in FIGS. 6C, 6D, and 6E, the controller 801 transmits signals to the camera actuator 503 in response to signals from the orientation sensor 417. The camera actuator 503 is configured to rotate the camera body 505 so that one of the first graphic information 509 or the second graphic information 609 is displayed in a proper orientation when the controller 801 determines that the sensor assembly 103 is in the standby mode. In some embodiments, the orientation sensor 417 is the hinge encoder of the hinge 303 (FIG. 3B).

Audible signals received by the first microphone assembly 405 and the second microphone assembly 419 are delivered to the controller 801 by use of a communication link. The audible signals are formed from audible inputs detected by the first microphone assembly 405 and the second microphone assembly 419. Stated otherwise, the audible inputs include inputs captured by the first microphone assembly 405 and the second microphone assembly 419. The audible signals can include a desired audible information provided by a desired audible source (i.e., the target meeting 201) and/or an undesired audible noise provided by an undesired audible source (e.g., secondary meeting 203).

In one or more embodiments, the controller 801 is configured to receive audible signals and output an audible transmission signal to one or more external electronic devices, such as, for example, video conferencing equipment that is positioned in a remote environment or a laptop positioned in the local environment. An algorithm running within the controller 801 is used to suppress undesired audible inputs captured by one of the first microphone assembly 405 and the second microphone assembly 419 compiled within the audible information provided in the audible transmission signal that is delivered to one or more external electronic devices. In one or more embodiments, the controller 801 utilizes the orientation of the first microphone assembly 405 and the second microphone assembly 419 to detect audible inputs, determines which inputs are noise inputs, and forms an audible transmission signal that is to be output to one or more external electronic devices.

In some embodiments, the first program 809, includes program code, which, when executed by processor 803, determines the orientation of the conferencing system assembly 100a using the orientation sensor 417. In one example, the controller 801 uses the first program 809 to determine the orientation of the conferencing system assembly 100a by comparing reference frame related data stored in the memory against one or more of the current conferencing system assembly orientation data determined by the orientation sensor 417, the angular position of the camera sensor 501 by use of data provided from the actuator encoder, and the angular position of the hinge 303 by use of data provided from the hinge encoder.

In some embodiments, the second program 811 is used to distinguish external noise from desired audible inputs based on time-of-flight and/or the direction from which audible inputs are received. The second program 811 includes instructions which, when executed by the processor 803 causes the controller 801 to perform operations that include determining a time difference between when the first microphone assembly 405 receives an audible input and when the second microphone assembly 419 receives the same audible input. Aspects of the process of distinguishing external noise from desired audible inputs performed by the second program 811 are discussed further below.

In some embodiments, the third program 813 is a direction determination program stored in the memory 805. The third program 813 includes instructions which, when executed by the processor 803 causes the controller 801 to perform operations that include calculating a time delay ratio and making a determination on which direction an audible input came from. The time delay ratio is calculated by comparing the time difference with a plurality of time delay ratios stored in the memory 805. The direction determination is made by determining whether the time delay ratio is closer to a first stored time delay ratio that is associated with a first direction than a second stored time delay ratio that is associated with a second direction.

In some embodiments, the first microphone assembly 405 and the second microphone assembly 419 each include multiple microphones. The controller 801 determines where an audible input is disposed relative to the sensor assembly 103 using a plurality of orders stored in the memory 805, the plurality of microphones of the first microphone assembly 405 and the second microphone assembly 419. For example, the controller 801 determines a detected order in which each microphone of the plurality of microphones receives the audible input. The controller 801 compares the detected order to a first stored order that is associated with a first direction and a second stored order that is associated with a second direction. The controller 801 determines a direction of the audible input based on whether the detected order is closer to the first stored order or the second stored order.

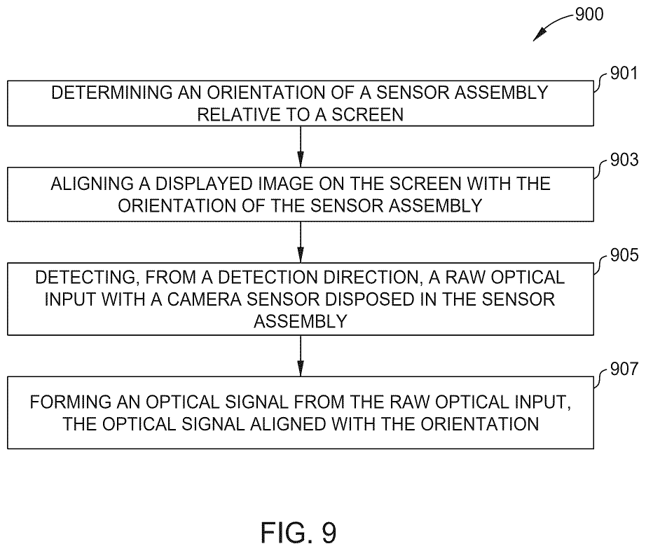

FIG. 9 illustrates a method 900 of generating video information and presenting the generated video information on the screen assembly 109 or to an external electronic device, according to one embodiment of the present disclosure. The method 900 can be used to enhance the information that is to be placed within a video signal transmission that is to be provided to the screen assembly 109 and/or one or more external electronic devices by determining an orientation of the camera sensor 501 relative to the sensor assembly 103 and/or a reference frame, and determining the orientation of the sensor assembly 103 relative to a screen assembly 109.

At operation 901, the controller 801 compares orientation information provided within a signal transmitted from the orientation sensor 417 with orientation information stored within memory to determine an orientation of the sensor assembly 103 relative to the screen assembly 109. For example, the stored orientation information includes prior detected orientation information provided from the orientation sensor 417 when the conferencing system assembly 100a is positioned at a known the first screen orientation 311 or the third orientation 331.

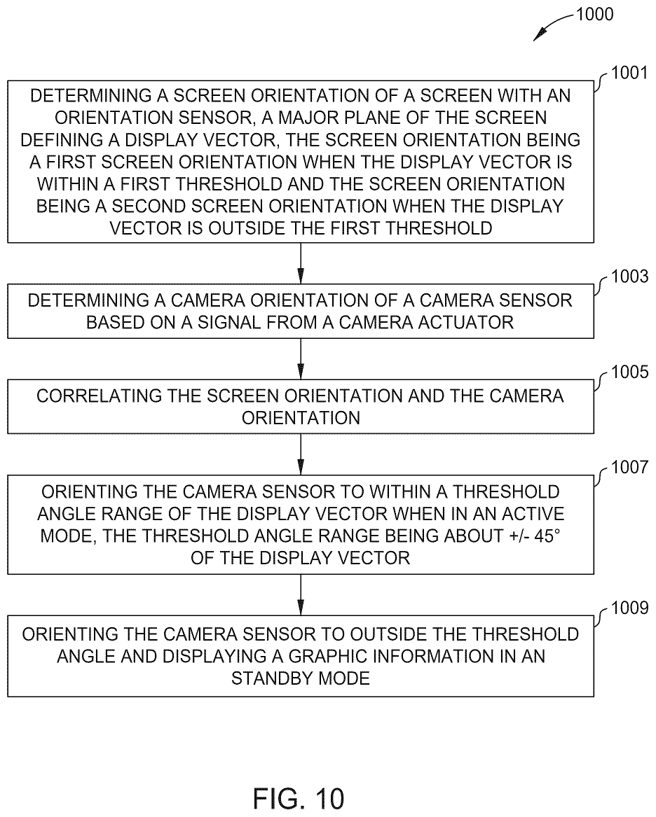

At operation 903 the camera sensor 501 generates an optical signal, which includes picture information, video information, or a combination thereof based on the orientation of the camera sensor 501 in the detection direction 525 and detected optical inputs from an optical input in the detection region 1241. The video information of the optical signal is in a first orientation. As will be discussed further below, orientation information of the camera sensor 501 may be determined by a method 1000, which is illustrated in FIG. 10. During operation 903, the controller 801 may utilize the determined orientation information to adjust the orientation of the camera sensor 501, as discussed above in relation to FIGS. 7A-7C and discussed below in relation to FIG. 10.

At operation 905 the controller 801 aligns a displayed image on the screen assembly 109 with the orientation of the sensor assembly 103, such as adjusting the displayed image to be in a first orientation or a second orientation that is flipped vertically (e.g., rotated 180° about a horizontal axis) relative to the first orientation. In some embodiments, the displayed image is an image received from the one or more external electronic devices (e.g., video conferencing equipment) positioned within a remote environment.

In some embodiments, operation 905 also includes the controller forming a video signal from the video information of the optical signal. The video information in the video signal may be oriented in a second orientation that is different from the first orientation of the video information if the controller 801 determines the video signal would subsequently form the basis of a displayed image, picture, or video in an improper orientation. For example, the video information in the video signal in the second orientation is flipped vertically from the video information in the first orientation.

At operation 907 the controller 801 forms a video transmission signal from the optical signal. The correct alignment of the video information in the optical input 523 having been provided to the controller 801 during operation 905, the camera sensor 501 forms and transmits a video signal to the controller 801 based on the optical input 523 so that the controller 801 can generate a video transmission signal that is then provided to the screen assembly 109 or to an external electronic device. The video transmission signal being correctly oriented and based on an orientation of the camera sensor 501. The displayed image may also include the visual signal from the camera sensor 501.

Method 900 enables an improved user experience when recording, attending, or participating in meeting because the controller 801 ensures the orientation of the recorded and/or transmitted signals is properly oriented without the need to interrupt the meeting or recording to address flipped or rotated signals being transmitted or recorded.

FIG. 10 illustrates the method 1000 of display orientation detection, according to one embodiments of the present disclosure.

At operation 1001 the controller 801 determines a screen orientation of the screen assembly 109 by at least the use of orientation information generated by the orientation sensor 417. As discussed above, the orientation sensor 417 is capable of detecting its orientation relative to a reference frame, such as determining its orientation relative to at least a gravitational direction (e.g., Z-direction) and its orientation relative to the yaw, pitch, and roll angles. The screen orientation is in the first screen orientation 311 when the display vector 111 orientation, which is determined from the orientation information generated by the orientation sensor 417, is within a first threshold value and the screen orientation is in the second screen orientation when the display vector 111 is outside of the first threshold value. For example, as shown in FIG. 3A, the display vector 111 is in the first threshold when the display vector 111 is parallel to the positive Y-axis to about 89° from the positive Y-axis, i.e., about 1° from about parallel to the positive Z-axis. In some embodiments, the controller 801 uses the orientation information generated by the orientation sensor 417 and angular information provided from the hinge encoder of the hinge 303 to determine the screen orientation.

In some embodiments, operation 1001 also includes the controller 801 determining a screen orientation of the screen assembly 109 by use of the orientation sensor 417. The orientation sensor 417 generates an orientation sensor signal. The controller 801 receives the orientation sensor signal and compares it to a first threshold value stored in the memory 805. The controller 801 determines a screen orientation of the screen by comparing the orientation sensor signal generated by the orientation sensor to the first threshold value stored in memory 805.

At operation 1003 the controller 801 determines a camera orientation of the camera sensor 501 based on a signal generated by the actuator encoder of the camera actuator 503. In some embodiments, the actuator encoder of the camera actuator 503 detects an angular position of the camera sensor 501 relative to a reference point within the camera assembly 500 that is referenced to a portion of the sensor assembly 103 (e.g., sensor assembly front surface) and thus the orientation of the orientation sensor 417. In other words, the controller 801 can determine the camera sensor's orientation based on a signal generated by use of the actuator encoder of the camera actuator 503 and a signal created by the orientation sensor 417. In one configuration, the camera actuator 503 has an internal calibration that defines the reference point and the controller 801 determines the angular position relative to the reference point to determine the camera orientation of the camera sensor 501 to a known portion of the conferencing system assembly 100 that is in a known orientation, which determined based on information provided from the orientation sensor 417.

In some embodiments, operation 1003 also includes determining a camera sensor orientation using an encoder of the hinge 303, orientation sensor 417, or combination thereof. For example, the encoder is coupled to the camera sensor 501, the actuator 503, or combination thereof. The controller 801 receives an encoder signal generated by the encoder and determines the camera sensor orientation based on the encoder signal.

At operation 1005 the controller 801 compares the screen orientation and the camera orientation based on the information provided by at least the orientation sensor 417 and the actuator encoder of the camera actuator 503 to determine the orientation of the camera sensor 501 relative to the external reference frame. In some embodiments, the orientation sensor 417 generates an orientation signal that is received by the controller 801. The controller 801

In some embodiments, operation 1005 also includes adjusting the orientation of the camera sensor 501 relative to the screen based on one or more of the orientation sensor signal and/or the encoder signal.

At operation 1007 the controller 801 is configured to cause the camera actuator 503 to orient the camera sensor 501 to a desired angular position within a threshold angle range of the display vector 111 when in the conferencing system assembly 100 is in use, such as when the conferencing system assembly 100 is active during a video conference, which is referred to herein as a conferencing mode. The threshold angle range is about +/−45° of the display vector 111 to the reference plane (e.g., horizontal plane) or reference direction (e.g., gravitational direction). For example, the controller 801 causes the camera actuator 503 to orient the sensor orientation vector 519 of the camera sensor 501 to within +/−45° of the display vector 111 of the screen assembly 109. For example, if the display vector 111 is directed towards the target meeting 201, the controller 801 transmits a signal to the camera actuator 503 to rotate the camera sensor 501 so that the sensor orientation vector 519 is directed toward an input source in the target meeting 201. In another example, when the conferencing system assembly 100a is in the third orientation 331 (FIG. 3C), the controller 801 will rotate the sensor orientation vector 519 closer to the display vector 111 to detect optical inputs nearer the conferencing system assembly 100a and rotate the sensor orientation vector 519 away from the display vector 111 to detect optical inputs farther from the conferencing system assembly 100a.

In some embodiments, operation 1007 also includes adjusting the orientation of the camera sensor 501 relative to the screen based on one or more of the orientation sensor signal and/or the encoder signal. For example, the controller 801 determines the orientation of the screen relative to the camera sensor 501 based on the orientation sensor signal, then adjusts the orientation of the camera sensor 501. Adjusting the orientation of the camera sensor 501 includes translating the camera sensor 501 in a first direction when in a first orientation and translating the camera sensor in a second direction when in a second orientation. In some embodiments, the first direction is clockwise and the second direction is counterclockwise.

At operation 1009, the controller 801 causes the camera actuator 503 to orient the camera sensor 501 to outside the threshold angle and display a graphic information when the conferencing system assembly 100a is in a standby mode. For example, when not in use the camera actuator 503 translates the camera body 505 to display one of the first graphic information 509 or the second graphic information 609 through the camera assembly aperture 403.

In some embodiments, the method 1000 also includes displaying an image on the screen assembly 109. During a video conference, the orientation of the screen assembly 109 determines if an image displayed thereon is correctly displayed, or upside down. For example, the controller 801 performs instructions from the first program 809 in the memory 805 that causes the controller 801 to determine a proper image orientation based on the orientation of the screen assembly 109, the image to be displayed on the screen assembly 109. The image is in a first orientation when the screen assembly 109 is in the first screen orientation 311 and the image on the screen assembly 109 is displayed in a second orientation, about 180° from the first orientation, when the screen assembly 109 is in the third orientation 331.

In some embodiments, the method 1000 includes displaying the first graphic information 509 when the sensor assembly 103 is in the standby mode and the sensor assembly 103 is disposed above the screen assembly 109. Similar to the image displayed on the screen assembly 109, the orientation of the sensor assembly 103 relative to the screen assembly 109 will affect which of the first graphic information 509 or second graphic information 609, when displayed through the camera assembly aperture 403, will be oriented correctly. For example, when the sensor assembly 103 is disposed above the screen assembly 109, the sensor assembly 103 is in the standby mode, and the first graphic information 509 and the second graphic information 609 are both a text logo, the first graphic information 509 will display the text logo in the correct orientation, but the second graphic information 609 will display the text logo upside-down if viewed through the camera assembly aperture 403. For example, displaying the first graphic information 509 when the conferencing system assembly 100a is in the first screen orientation 311, as seen in FIG. 3A. The controller 801 determines which of which the first graphic region 507 or the second graphic region 607 to display based on the orientation of the screen assembly 109 relative to the camera sensor 501. In some embodiments, the method 1000 includes displaying the second graphic information 609 when the sensor assembly 103 is in the standby mode and the sensor assembly is disposed below the screen assembly 109. For example, displaying the second graphic information 609 when the conferencing system assembly 100a is in the third orientation 331, as seen in FIG. 3C. In some embodiments, the method 1000 includes directing the camera sensor 501 about parallel to the detection vector 411 when in the conference mode. In some embodiments, the method 1000 is the fourth program 815 stored in the memory 805.

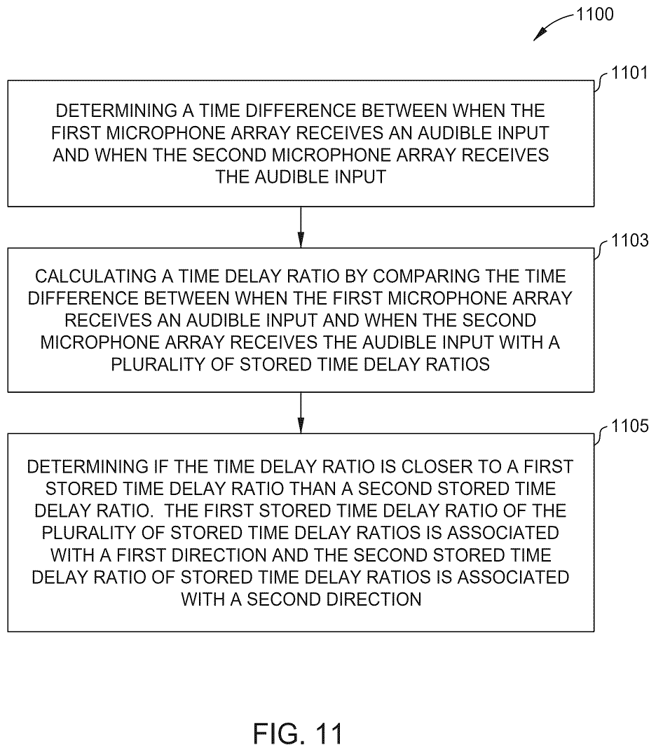

FIG. 11 illustrates a method 1100 of determining a direction from which an audible input and a noise input are received based on information received from the first microphone assembly 405 and the second microphone assembly 419, according to one embodiments of the present disclosure. Based on the timing of when each of the microphones receives the audible information within the audible inputs from the first microphone assembly 405 and each of the microphones in the second microphone assembly 419, an algorithm running on the controller 801 can determine the position of the various audible sources positioned around the conferencing system assembly 100. The determined position of an audible source can be used to determine that undesirable audible information (i.e., noise) is received from a source, which is not in a desired position relative to the conferencing system assembly (e.g., not on a desired side of the conferencing system assembly 100) can be suppressed by use of the algorithm relative to desirable audible information received from a desired position relative to the conferencing system assembly. Therefore, during the operations performed during method 1100, the algorithm can determine that the received audible input is in fact an undesired audible input because the received audible source is located at a location nearer to the two or more microphones within the first microphone assembly 405 versus the two or more microphones within the second microphone assembly 419.

At operation 1101 of the method 1100, the controller 801 (FIG. 8) determines a time difference between when the first microphone assembly 405 receives an audible input and when the second microphone assembly 419 receives the audible input. During operation 1101, which can be performed by use of the algorithm of the second program 811, the first microphone assembly 405 and the second microphone assembly 419, the algorithm, which is running within the controller 801, determines when various captured audible inputs were received, by the microphones within the first microphone assembly 405 and the second microphone assembly 419, from the environment in which the conferencing system assembly 100 is disposed.

At operation 1103, the controller 801 compares a time delay by comparing the time difference between when the first microphone assembly 405 receives an audible input and when the second microphone assembly 419 receives the same audible input. The controller may also determine a time delay ratio, or ratio of the time difference between when the first microphone assembly 405 received the audible input to when the second microphone assembly 419 received the same audible input. The determined time delay ratio can then be compared with time delay ratio values stored in memory to determine the position of the audible input relative to the detected or known orientation of the conferencing system assembly 100. The stored time delay ratios may be associated with vectors which enables the controller 801 to determine the vector from which the input originated.

At operation 1105, the controller 801 determines if the time delay ratio is closer to a first stored time delay ratio value than a second stored time delay ratio value. The first stored time delay ratio of the plurality of stored time delay ratios is associated with a first direction and the second stored time delay ratio of stored time delay ratios is associated with a second direction. By having the first microphone assembly 405 and the second microphone assembly 419 at different locations, the time difference is created between when each microphone assembly receives the same audible input allows the controller 801 to determine the location of the input source and determine if the source is background noise. In addition, the first microphone assembly 405 having two or more microphones enables the controller 801 to use the time differences from the two or more microphones in the first microphone assembly 405 to determine a vector and position of the audible input source relative to the front side of the sensor assembly 103. Similarly, the second microphone assembly 419 having two or more microphones enables the controller 801 to use the time differences between the two or more microphones in the second microphone assembly 419 to determine a vector and position of the audible input source relative to the rear side of the sensor assembly 103. Based on at least one of the determined vectors, the controller 801 is able to determine if the audible input is noise that should be filtered out form subsequently generated signals.

After determining that a received audible input is an undesirable audible input (e.g., noise) based on the determined direction of the audible source and the orientation signal, the algorithm generates an adjusted audible signal which can then transmitted to an external electronic device (e.g., laptop, smart phone, recording device, tablet, display, television, etc.) in the same local environment or another external environment. In one or more embodiments, the adjusted audible signal is generated by altering a portion of the received audible inputs upon determining that the time delay between when the two or more microphones within the first microphone assembly 405 versus the two or more microphones within the second microphone assembly 419 receive the audible input and/or a time difference between when the audible input was received by the two or more microphones within the first microphone assembly 405 versus the two or more microphones within the second microphone assembly 419 is not substantially equal to a target time delay value stored in the memory of the controller 801. The process of determining whether there is a delay or a delay is within a target delay can be performed by the algorithm by comparing the various detected audible signatures found within the received audible input. In one or more embodiments, altering a portion of the received audible input (composite audible input) includes suppressing the undesired audible input within the received audible input. As noted above, the audible input is suppressed if the algorithm determines that the audible input is undesired noise. The algorithm suppresses the undesired audible input by determining the signature of the audible input and suppressing it by attenuating its portion of a composite audible input. The algorithm may determine the unique signature of the audible input by correlating the signature of audible input with the time each microphone receives the audible input.

In one or more embodiments, if the time in which the signature corresponding to the desired audible input and the undesired audible input overlap, the sound-pressure-level (SPL) of a composite audible input is the combined (sum of the) SPL of the desired audible input and the undesired audible input. Therefore, the SPL of the composite audible input is partially suppressed to remove the additional SPL of the composite audible input that is attributed to the undesired audible input. Stated otherwise, any SPL included in the composite audible input that is greater than the SPL correlated to the desired audible input is suppressed. On the other hand, if times in which only the signature of the undesired audible input is received (i.e., no portion of the audible input can be attributed to the desired audible source), the entire composite audible input is suppressed. During times in which only the signature of the desired audible input from the desired audible source is received, no part of the composite audible input will be suppressed.

The above described method enables the controller 801 to determine which input is from a desired direction and which audible input is noise. For example, the audible input from the target meeting 201 (FIG. 2) would be the desired input and any audible input from the secondary meeting 203 would be the noise. The controller 801 would filter out the noise so that recorded and/or transmitted signals include a clean audible signal with the audible input from the target meeting 201 but the audible input from the secondary meeting 203 being filtered out prior to recording or transmission.

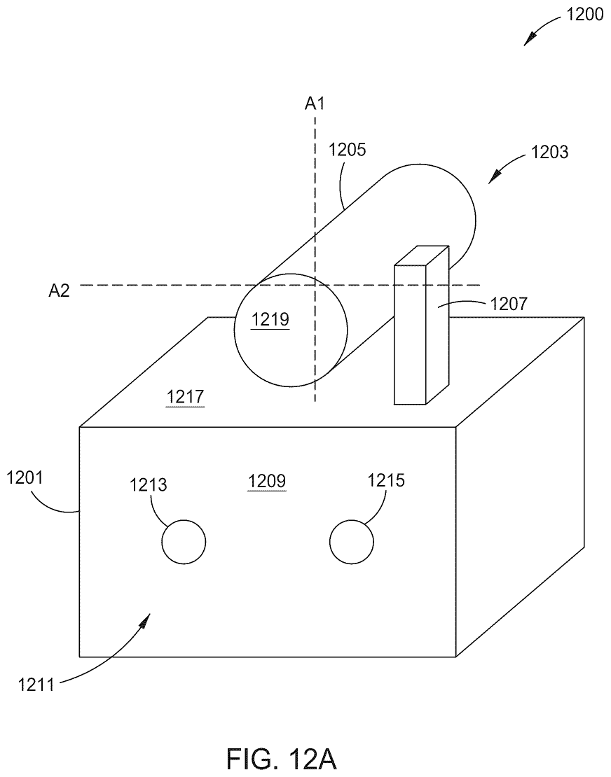

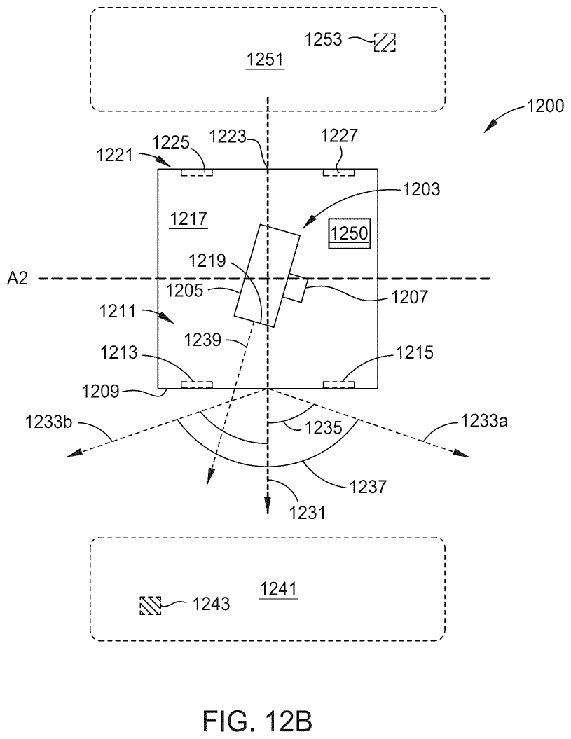

FIG. 12A is a perspective view of a video conference assembly 1200, according to one or more embodiments of the present disclosure. FIG. 12B is a top view of the video conference assembly 1200, according to one or more embodiments of the present disclosure. As shown in FIG. 12A, the video conference assembly 1200 includes a base 1201 and a camera assembly 1203. The camera assembly 1203 includes a camera sensor 1205 coupled to the base 1201 by a camera actuator 1207. The camera sensor 1205 includes a lens 1219. The camera sensor 1205 detects optical and/or visual inputs through the lens 1219. The camera actuator 1207 is coupled to a top surface 1217 of the base 1201. The camera actuator 1207 enables the camera sensor 1205 to be translated about a first axis A1 and about a second axis A2. In some embodiments, the first axis A1 is a vertical axis perpendicular to the top surface 1217 of the base 1201. In some embodiments, the second axis A2 is a horizontal axis about parallel to the top surface 1217. For example, the first axis A1 is disposed at an angle to the second axis A2 and the front vector 1231 is aligned about perpendicular to the front surface 1209..

The base 1201 includes a front surface 1209 and a front microphone assembly 1211 coupled to the front surface 1209. The front microphone assembly 1211 includes a plurality of microphones. In some embodiments, the front microphone assembly 1211 includes a first front microphone 1213 and a second front microphone 1215. In one configuration, the camera sensor 1205 is positioned between the first front microphone 1213 and the second front microphone 1215. In some embodiments, the first axis A1 is disposed between the first front microphone 1213 and the second front microphone 1215, such as the first axis bisects a distance between the first front microphone 1213 and the second front microphone 1215.

As shown in FIG. 12B, the video conference assembly 1200 includes a controller 1250 and a rear microphone assembly 1221, which is on an opposite side of the base 1201 from the front microphone assembly 1211 and in some cases can be coupled to a rear surface 1223 of the base 1201. In some embodiments, the controller 1250 is the controller 801 (FIG. 8) described above. The rear microphone assembly 1221 includes a first rear microphone 1225 and a second rear microphone 1227. The front surface 1209 and the rear surface 1223 are separated by the top surface 1217. In some embodiments, the front microphone assembly 1211 and the rear microphone assembly 1221 each include a plurality of microphones, such as two or more microphones.

The lens 1219 defines a detection vector 1239 perpendicular to the plane of the lens 1219. The detection vector 1239 is the direction from which the camera sensor 1205 is detecting inputs. As the camera actuator 1207 translates the camera sensor 1205, the detection vector 1239 orientation changes.

The front surface 1209 defines a front vector 1231 extending from the front surface 1209 of the base 1201. In some embodiments the front surface 1209 faces a detection region 1241. The front vector 1231 is directed towards the detection region 1241. The detection region 1241 includes a target input source 1243 disposed therein. The target input source 1243 emits audible and visual inputs that are detectable by the video conference assembly 1200. In some embodiments, a rear zone 1251 is disposed outside of the detection region 1241. For example, the rear zone 1251 is disposed opposite the front vector 1231. For example, the detection region 1241 and the rear zone 1251 are on opposite sides of the base 1201. In some embodiments, the rear zone 1251 includes a rear input source 1253 disposed in the rear zone 1251. The rear input source 1253 emits audible and visual inputs that are detectable by the video conference assembly 1200.

In some embodiments, the detection region 1241 is defined as within a threshold angle 1235 of the front vector 1231. The threshold angle 1235 is the angle between the front vector 1231 and a first bounding vector 1233a or a second bounding vector 1233b. A range 1237 is the field of view of the video conference assembly 1200. The range 1237 is bound by the first bounding vector 1233a and the second bounding vector 1233b. The threshold angle 1235 is about 30° to about 95°. In some embodiments, the first bounding vector 1233a and the second bounding vector 1233b define the detection region 1241. The range 1237 is a function of the threshold angle 1235.

The camera actuator 1207 translates the camera sensor 1205 so that the detection vector 1239 is oriented and directed towards inputs within the detection region 1241. In some embodiments, the range 1237 defines the detection region 1241 with the target input source 1243 disposed therein. Input sources disposed outside of the first bounding vector 1233a and the second bounding vector 1233b are rear input sources 1253 disposed outside of the detection region 1241. The one or more are unknown input sources that produce detectable audible sound inputs. The controller 1250 determines a sound input direction from each of the one or more are unknown input sources to the video conference assembly 1200. The controller 1250 determines if the unknown input source is a target input source 1243 or a rear input source 1253. The controller 1250 directs the camera actuator 1207 to translate the camera sensor 1205 and orient the detection vector 1239 along the sound input direction when the input source is a target input source 1243.

The controller 1250 of the video conference assembly 1200 is able to perform the method 900, the method 1000, and the method 1100. The video conference assembly 1200 is able to better differentiate between desired audible inputs and noise and suppress noise in-part due to the front microphone assembly 1211 and the rear microphone assembly 1221. In addition to the enhanced noise mitigation, the front microphone assembly 1211 and the rear microphone assembly 1221 enhance the ability of the controller 1250 to orient the camera sensor 1205 towards the target input source 1243.

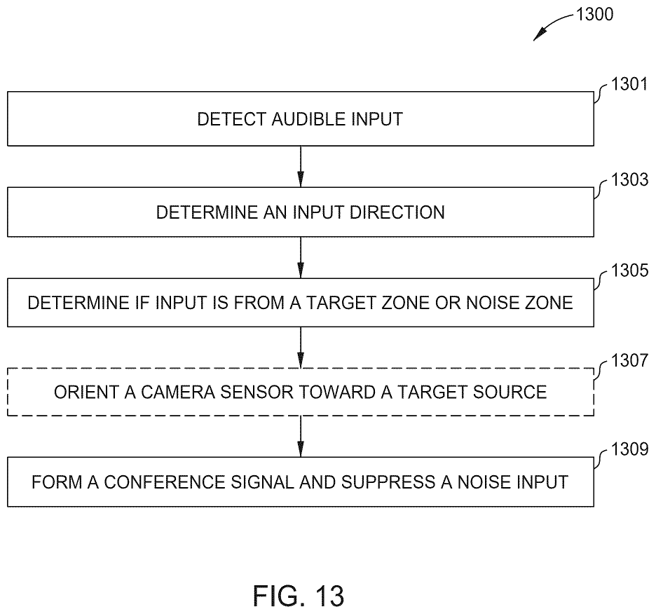

FIG. 13 illustrates a method 1300 of orienting a camera sensor while suppressing audible noise from audible input sources, according to one embodiments of the present disclosure. The controller 1250 (FIG. 12B) includes one or more stored programs that when executed by the processor 803 (FIG. 8) performs the method 1300. The method 1300 may be performed by the sensor assembly 103 or the video conference assembly 1200. The method 1300 enables the controller 1250 to suppress audible inputs from an environment with desired and undesired audible input sources.

At operation 1301 of the method 1300, the video conference assembly 1200 detects an audible input from an input source with a plurality of microphones disposed in video conference assembly. The audible input may be an audible input from the target input source 1243. The plurality of microphones may be the front microphone assembly 1211 and/or rear microphone assembly 1221.

At operation 1305 of the method 1300, the controller 1250 determines an order of when each microphone of the plurality of microphones detects the audible input. For example, the front microphone assembly 1211 and the rear microphone assembly 1221 each detect the audible input at different times. In yet another example, the first front microphone 1213, the second front microphone 1215, the first rear microphone 1225, and the second rear microphone 1227 each detect the audible input at different times. The order and time difference between when each microphone time

At operation 1305, the controller 1250 determines a direction of the audible input source based on the order in time. For example, the first front microphone 1213 or the second front microphone 1215 detects the audible input before the rear microphone assembly 1221 when the audible input is the front input from the target input source 1243 and disposed in the detection region 1241.

Operation 1307 includes orienting the detection vector 1239 of the camera sensor 1205 toward the input source when the input source is the target input source 1243. In some embodiments, the input source is the target input source 1243 when the front microphone assembly 1211 detects the audible input and the controller 1250 determines the direction to orient the detection vector 1239 is within range 1237. For example, the controller 801 determines if the audible input is a front input from a target input source 1243 disposed in a detection region 1241 or a noise input from a rear input source 1253 disposed outside of the detection region 1241.

.In some embodiments, the method 1300 further includes operation 1309 where the controller 1250 forms and transmits a conference signal. The conference signal includes a signal that includes audible data and visual data that can subsequently be displayed in the proper orientation with reduced noise. For example, the controller 1250 is configured for transmitting the conference signal having audible and video data detected from the detection region 1241 by the video conference assembly 1200 and the controller 801 has determined the orientation of the camera assembly 1203 relative to the reference plane 301 (e.g., floor of the environment) so that the conference signal is correctly oriented (e.g. the recipient of the conference signal does not need to rotate an image derived from the visual data or filter noise from the audible data).

.For example, the controller 1250 transmits the conference signal as a video stream. The forming of the conference signal includes forming a target signal from the target input with the controller 1250, forming a noise signal from the rear input with the controller 1250, and filtering the noise signal from the target signal to form the audible data of the conference signal. In some embodiments, the conference signal further includes the video signal from the input detected by the camera sensor 120. In some embodiments, the method 1300 is the fifth program 817 stored in the memory 805.

This method 1300 enables audible target input detection and noise suppression based on audible input direction and camera orientation, for improved conferencing and conference signal transmission. The video conference assembly 1200 can also perform method 1100 so the audible data of the conference signal has reduced noise from sources outside of the detection region 1241. The multiple microphones of video conference assembly 1200, further enhances noise suppression by enabling the controller 801 to determine if an audible input is in front of or behind the video conference assembly 1200, and thereby determine if the audible input is noise. In one example, the controller 801 is used to determine that audible sources that are not in the FOV of camera sensor 1205 of the camera assembly 1203 are noise-generating sources that can then be suppressed by the use of one or more of the techniques described herein.

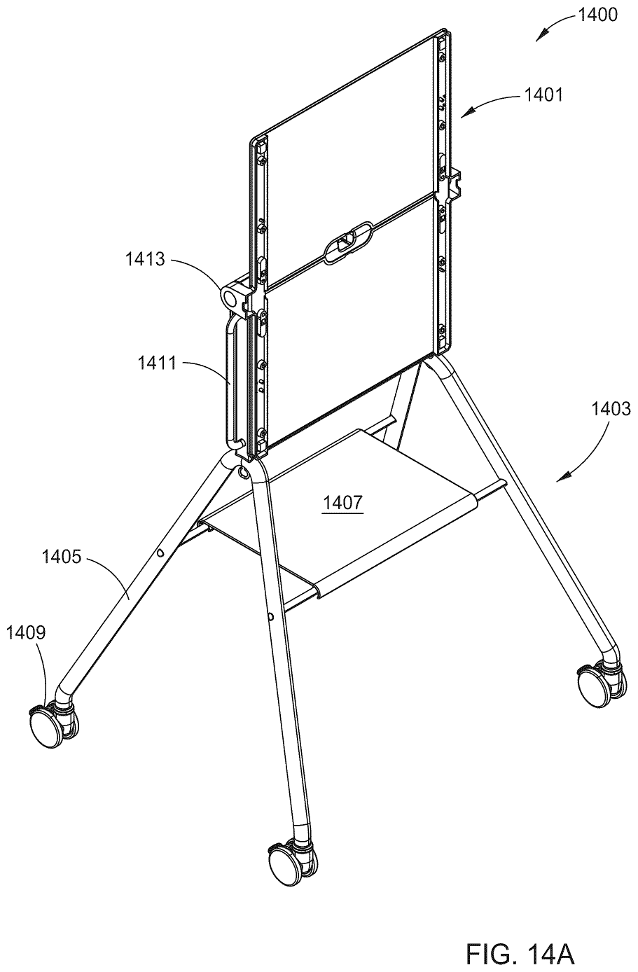

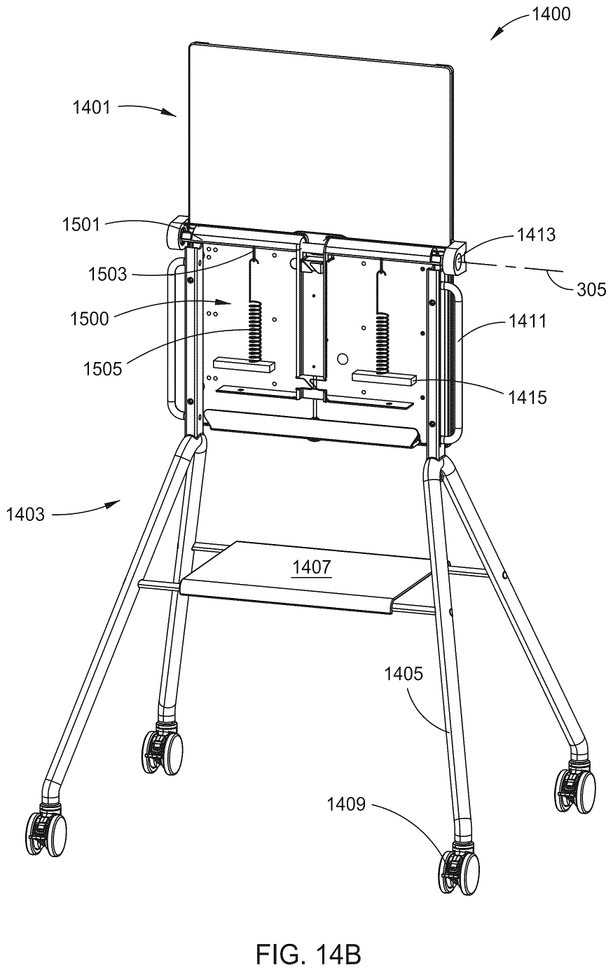

FIG. 14A is a front isometric view of a screen support assembly 1400, according to one or more embodiments of the present disclosure. The screen support assembly 1400 is similar to the structural member 101, the screen mounting structure 127, and the movable frame 105 of FIG. 1D.

The screen support assembly 1400, includes a screen mounting structure 1401 coupled to a structural member 1403. The structural member 1403 includes legs 1405 that are coupled by a support frame 1407. The legs 1405 each include a casters 1409 disposed at an end of each leg opposite the mounting structure 1401. The support frame 1407 attaches to the legs 1405 between and a vertical extension 1411 of the structural member 1403. The vertical extensions 1411 are perpendicular to a major plane of the support frame 1407. The vertical extensions 1411 are coupled by a rod 1413. The rod 1413 may be a hinge that couples screen the mounting structure 1401 to the structural member 1403. The rod 1413 enables the mounting structure 1401 to rotate about an axis of rotation defined by the rod 1413. The rod 1413 is rigidly coupled to the structural member 1403 and able to rotate within apertures of the vertical extensions 1411. Rigidly coupled as defined herein includes in direct contact with and affixed. In some embodiments, the vertical extensions 1411 form a first support mount and a second support mount.

FIG. 14B is a back isometric view of the screen support assembly 1400, according to one or more embodiments of the present disclosure. The screen support assembly 1400 includes a dampening system 1500 coupled to the screen mounting structure 1401, the structural member 1403, and the rod 1413.

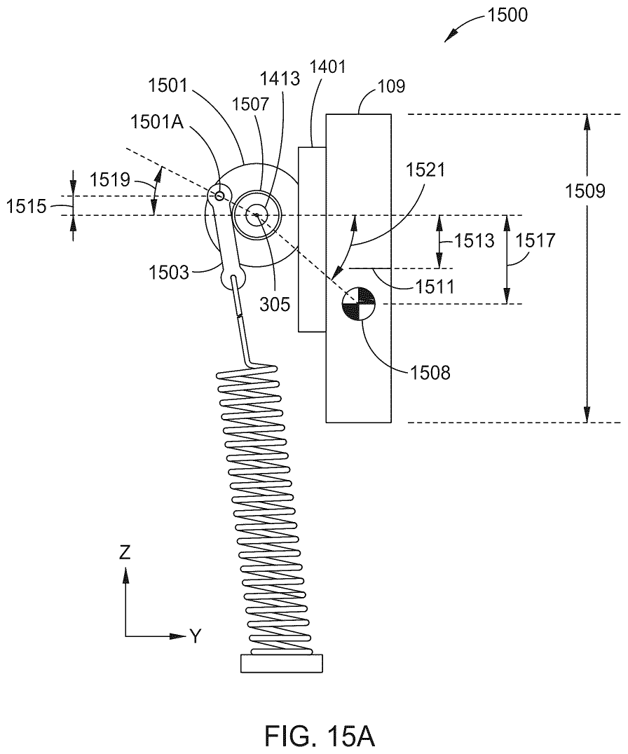

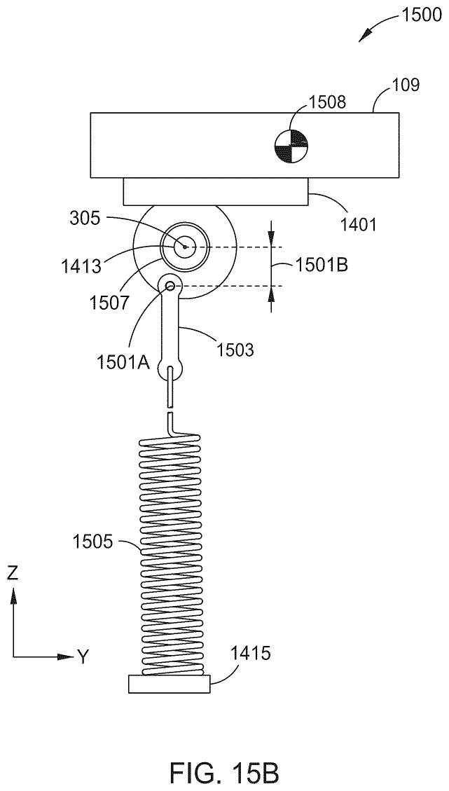

FIGS. 15A and 15B are schematic views of the dampening system 1500 according to one or more embodiments of the present disclosure.

The dampening system 1500 includes an offset disc 1501, a connector 1503, and a resistive element 1505. In some embodiments, the resistive element 1505 is a tension spring is coupled to a spring mount 1415 of the structural member 1403. The spring mount 1415 is rigidly connected to the structural member 1403 and provides an anchor to attach the resistive element 1505. While illustrated as having two of each of the offset disc 1501, the connector 1503, and the resistive element 1505, other embodiments with multiple are contemplated. For example, the dampening system 1500 may include two or more of each of the offset disc 1501, the connector 1503, and the resistive element 1505 to form multiple a plurality of offset disc assemblies rigidly connected to the screen assembly 109. The dampening system 1500 will be described in more detail below.

In some embodiments, the dampening system 1500 further includes and a torsion spring 1507. The offset disc 1501 is rigidly connected to the rod 1413. For example, the offset disc 1501 rotates with the rod 1413. The resistive element 1505 is connected to the spring mount 1415 and the connector 1503. In some embodiments, the resistive element 1505 is configured to resist movement of the screen assembly about the axis of rotation as the screen assembly translates away from the neutral orientation of FIG. 15B or second screen orientation 321 (FIG. 3B). The connector 1503 is coupled to the offset disc 1501 opposite from the screen mounting structure 1401. The connector 1503, and/or resistive element 1505, is coupled to the offset disc 1501 at a connection point 1501A that is positioned a distance 1501B from the central axis of the rod 1413. The offset connection formed by the offset disc 1501, the connector 1503 and the resistive element 1505 enables the resistive element 1505 to account for the weight of the screen assembly 109 is coupled to the mounting structure 1401. In some embodiments, the offset disc 1501 includes an aperture that is concentric with the axis of rotation 305 of the rod 1413.

In some embodiments, ends of the torsion spring 1507 is rigidly coupled to the rod 1413 and the structural member 1403 (FIG. 14B). The torsion spring 1507 is disposed around the rod 1413 and resists the moment caused when the screen assembly 109 transitions from the second screen orientation 321 (FIG. 3B) to the first screen orientation 311 (FIG. 3A) or the third orientation 331 (FIG. 3C).

As shown in FIG. 15A, the dampening system 1500 is in a flexed position with the resistive element 1505 and the torsion spring 1507 in tension and applying force to the screen mounting structure 1401 through the rod 1413. As shown in FIG. 15B, the dampening system 1500 is in a relaxed position such that rotational force applied by the resistive element 1505 and the torsion spring 1507 is less than when the dampening system 1500 is in a flexed position as shown in FIG. 15A. When the dampening system 1500 is in the relaxed position, the screen mounting structure 1401 is disposed over the offset disc 1501, the connector 1503, the resistive element 1505, and the spring mount 1415. For example, the rod 1413 is disposed between the screen mounting structure 1401 and the spring mount 1415 when the dampening system 1500 is in the relaxed position. In some embodiments, the screen mounting structure 1401 is disposed perpendicular to the spring mount 1415 when the dampening system 1500 is in the flexed position.

When the screen mounting structure 1401 is coupled to the screen assembly 109 (FIG. 1D) in one of the first screen orientation 311 (FIG. 3A) or the third orientation 331 (FIG. 3C), the dampening system 1500 is applying rotational force to dispose the screen assembly 109 (FIG. 1D) in the second screen orientation 321 (FIG. 3B and FIG. 15B). The dampening system 1500 biases the screen assembly 109 toward the neutral orientation over the structural member 1403. The neutral orientation disposed the screen assembly 109 between the first orientation 311 and the third orientation 331 (FIG. 3C).

The screen assembly 109 has the center of mass 1508, a height 1509, and a midpoint 1511 of the height 1509. The midpoint 1511 is disposed about halfway of the height 1509. In some embodiments, when in the flexed position shown in FIG. 15A, the midpoint 1511 is disposed at an offset 1513 from the normal vector of the axis the rotation 305 in the Y direction. In some embodiments, the connection point 1501A is disposed a corresponding offset 1515 from the axis the rotation 305 in the Y direction opposite the center of mass 1508. The center of mass 1508 is disposed at a center of mass offset 1517 from the axis the rotation 305 in the Y direction opposite the connection point 1501A. The connection point 1501A is disposed at an angular offset 1519 that is related to an angular offset 1521 of the center of mass 1508 of the screen assembly 109. The angular offset 1519 is the angle formed by the vector between the connection point 1501A and a horizontal plane, the axis of rotation 305 disposed therein.

In some embodiments, when in the neutral orientation, the center of mass 1508 of the screen assembly 109 is disposed closer to one of orientations and the connection point 1501A is disposed opposite the axis of rotation 305 and closer to the other orientation. For example, the dampening system 1500 establishes the neutral orientation of the screen assembly 109.

In some embodiments, the center of mass 1508 is offset from the axis the rotation 305 in both the X and Y directions. In some embodiments, the flexed position of FIG. 15A is the first screen orientation 311 and is a generally upright position. In the first screen orientation 311 (FIG. 3A) as shown in FIG. 15A, the center of mass 1508 is disposed below the axis the rotation 305 in the Y direction. The dampening system 1500 can rotate the screen assembly 109 to a second position, opposite of the first position. The second position is generally upside down where the center of mass 1508 is over the axis the rotation 305 in the Y direction. In some embodiments, the center of mass 1508 is disposed closer to the spring mount 1415 than the axis the rotation 305 in the first position and the spring mount 1415 is disposed closer to the axis the rotation 305 in the second position. The dampening system 1500 is configured to account for the center of mass 1508 being offset from the midpoint 1511. The dampening system 1500 enables the screen assembly 109 to rotate about the axis of rotation 305 by 180 degrees or more.

The dampening system 1500 enables dampened rotation and movement of the screen mounting structure 1401 and a coupled screen assembly 109 by compensating for the weight of the screen mounting structure 1401 (FIG. 14A) and the screen assembly 109 with spring force. The dampening effect of the dampening system 1500 work against gravity to reduce the angular acceleration the screen assembly 109 (FIG. 1D) would experience as the screen assembly 109 translates from the second screen orientation 321 (FIG. 3B) to the first screen orientation 311 (FIG. 3A) or the third orientation 331 (FIG. 3C). The dampening effect reduces the possibility of injury by slowing down the speed of rotation and further enhances durability of the screen support assembly 1400 by reducing potential impact forces the screen assembly 109 (FIG. 1D) may experience during use.

As shown in FIGS. 14A, 14B, 15A, and 15B, in some embodiments, the conferencing system assembly 100 (FIG. 1) includes the screen mounting structure 1401 and structural member 1403. The structural member 1403 includes a support structure. The support structure may be the vertical extensions 1411. The vertical extensions 1411 have apertures for the rod 1413 and define the axis of rotation 305 (FIG. 3). In some embodiments, the dampening system 1500 is configured to dispose the screen assembly 109 in the first position when the screen assembly translates 30 degrees or more towards the first orientation from the third orientation.

The subject matter has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Benefits of the present disclosure include enhanced input detection abilities, noise suppression within formed conference signals, graphic information display relative to screen orientation and correlation between displayed screen images and relative to detected input orientation.

It is contemplated that one or more aspects disclosed herein may be combined. As an example, one or more aspects, features, components, operations and/or properties of the conferencing system assembly 100a shown in FIG. 2, the sensor assembly 103 shown in FIG. 4A, the camera assembly 500 shown in FIG. 5, the controller 801 shown in FIG. 8, the method 900 shown in FIG. 9, the method 1000 shown in FIG. 10, the method 1100 shown in FIG. 11, the video conference assembly 1200 shown in FIGS. 12A and 12B, and the method 1300 shown in FIG. 13 maybe be combined. Moreover, it is contemplated that one or more aspects disclosed herein may include some or all of the aforementioned benefits.

Embodiments of the disclosure include a video conferencing assembly comprising: a camera assembly, a front microphone assembly, a rear microphone assembly, and a controller. The camera assembly, which is coupled to a frame, can include a camera sensor defining a detection vector oriented towards a detection region; and a camera actuator coupled to the frame, the camera actuator configured to translate the camera sensor to direct the detection vector of the camera sensor within the detection region. The front microphone assembly is coupled to a front surface of the frame and is directed towards the detection region, the front microphone assembly comprising: a first front microphone; and a second front microphone. The rear microphone assembly is coupled to a rear surface of the frame and is directed towards a rear zone, the rear surface disposed facing the rear zone. The controller can include a processor; and a memory having a stored program stored in the memory, the stored program comprising a method to form and transmit a conference signal. The method includes detecting a target input from a target input source with the front microphone assembly and the rear microphone assembly, determining a direction of the target input source based on the target input detected by the front microphone assembly and the rear microphone assembly, and orienting the detection vector towards the target input source.

While the foregoing is directed to embodiments of the present disclosure, other and further embodiments of the disclosure may be devised without departing from the basic scope thereof, and the scope thereof is determined by the claims that follow.

What is claimed:

1. A method, comprising:
detecting, by use of a plurality of microphones, an audible input from an input source;
determining, by a controller, a direction of the input source based on a difference in time that two or more microphones of the plurality of microphones detected the audible input;
generating, by use of an orientation sensor that is coupled to a camera sensor, an orientation signal; and
orienting the camera sensor, by use of a camera actuator coupled to the camera sensor, wherein the camera sensor is oriented towards the input source based on the direction determined by the controller and the orientation signal.

2. The method of claim 1, wherein the plurality of microphones comprises:
a first microphone assembly coupled to a front surface of a base of a video conference assembly, the first microphone assembly comprising:
a first microphone; and
a second microphone; and
a rear microphone assembly coupled to a rear surface of the base.

3. The method of claim 2, wherein the first microphone or the second microphone detects the audible input before the rear microphone assembly when the audible input is a target input from a target input source disposed in a detection region.

4. The method of claim 3, further comprising:
forming a conference signal comprising audible data and visual data, wherein forming the conference signal comprises:
receiving a target signal from the target input;
receiving a noise signal from a noise input source disposed outside of the detection region; and
filtering the noise signal from the target signal to form the audible data.

5. The method of claim 3, wherein orienting a sensor orientation vector includes orienting the sensor orientation vector of the camera sensor towards the target input source.

6. The method of claim 1, further comprising:
determining if the audible input is a target input from a target input source disposed in a detection region or if the audible input is a noise input from a rear input source disposed outside of the detection region.

7. The method of claim 1, wherein orienting a sensor orientation vector includes translating the camera sensor about one or more of a first axis and a second axis of a base of a video conference assembly.

8. The method of claim 1, further comprising:
determining if the input source is disposed within a detection region or a rear zone, the detection region defined as within a threshold angle of a front vector, the front vector extending from a front surface of a video conference assembly.

9. The method of claim 8, wherein the threshold angle is within +/-90°from the front vector.

10. The method of claim 8, wherein the front vector is directed towards the detection region.

11. A method, comprising:
determining, by use of an orientation sensor, a screen orientation of a screen by comparing an orientation sensor signal generated by the orientation sensor to a first threshold value stored in memory;
determining a camera sensor orientation using an encoder coupled to the camera sensor, the camera sensor orientation determined based on an encoder signal generated by the encoder; and
adjusting the orientation of the camera sensor relative to the screen based on the encoder signal and the orientation sensor signal.

12. The method of claim 11, further comprising:
determining the orientation of the screen relative to the camera sensor based on the orientation sensor signal, wherein adjusting the orientation of the camera sensor includes translating the camera sensor in a first direction when in a first orientation and translating the camera sensor in a second direction when in a second orientation.

13. The method of claim 12, wherein translating the camera sensor includes rotating, by use of a camera actuator, the camera sensor about a camera axis, wherein the first direction being clockwise and the second direction being counterclockwise about the camera axis.

14. The method of claim 11, further comprising orientating the camera sensor to display a graphic region through a camera assembly aperture.

15. The method of claim 14, wherein displaying the graphic region includes displaying a first graphic region or second graphic region after determining which of the first graphic region or the second graphic region will be in a correct orientation based on the orientation of the camera sensor.

16. The method of claim 15, wherein
the first graphic region comprises a first graphic information,
the second graphic region comprises a second graphic information, and
the first graphic information and the second graphic information form an ambigram.

17. A method, comprising:
comparing an orientation signal from an orientation sensor with orientation information stored in a memory of a controller coupled to a camera sensor to determine an orientation of the camera sensor;
generating, by a camera sensor, an optical signal based on an optical input detected from within a detection region of the camera sensor, wherein the optical signal comprises video information that is oriented in a first orientation; and
forming, by the controller, a video signal that comprises the video information, wherein the video information in the video signal is oriented in a second orientation that is different from the first orientation.

18. The method of claim 17, wherein the video information in the first orientation is flipped vertically from the video information in the second orientation.

19. The method of claim 17, further comprising:
generating a video transmission signal from the video signal;
transmitting the video transmission signal to a screen; and
displaying an image on the screen based on the orientation of the camera sensor.

20. The method of claim 17, wherein the orientation of the camera sensor is based on the orientation of a screen relative to the camera sensor.
